(19) United States
(12) Patent Application Publication
(10) Pub. No.: US 2026/0311342 A1
(43) Pub. Date: Oct. 8, 2026

(54) SYSTEM AND METHOD FOR CALIBRATING 3D SENSOR COORDINATE BASED ON SCENE FLOW NETWORK

(71) Applicants: Hyundai Motor Company, Seoul (KR); Kia Corporation, Seoul (KR)

(72) Inventors: Hyeon Jun LIM, Hwaseong-Si (KR); Dong Wook SHU, Hwaseong-Si (KR); Ju Heon BAEG, Hwaseong-Si (KR); Su Rin JO, Hwaseong-Si (KR)

(21) Appl. No.: 19/406,040

(22) Filed: Dec. 2, 2025

(30) Foreign Application Priority Data
Apr. 2, 2025 (KR) 10-2025-0042966

(51) Int. Cl. G06T 7/215; B60W 60/00; G06V 10/764; G06V 20/56

(52) U.S. Cl. CPC G06T 7/215; B60W 60/001; G06V 10/764; G06V 20/56

(57) ABSTRACT

A system and a method for recognizing an object by an artificial intelligence (AI) module and an autonomous driving sensor are disclosed. The AI module performs a first step for training and executing the scene flow network, which outputs a scene flow, in real time based on input data from the autonomous driving sensor, a second step for performing motion segmentation with respect to points including a static object or a dynamic object present under the surrounding environment, a third step for extracting a representative static object vector by applying a particle filter to the input data, which is temporally and spatially accumulated, from the autonomous driving sensor, and a fourth step for calibrating coordinates of the autonomous driving sensor, using at least one of a roll value, a pitch value, a yaw value, or a z value of the representative static object vector.

### CROSS-REFERENCE TO RELATED APPLICATION

This application claims the benefit of priority to Korean Patent Application No. 10-2025-0042966, filed in the Korean Intellectual Property Office on Apr. 2, 2025, the entire contents of which are incorporated herein by reference.

### TECHNICAL FIELD

The present disclosure relates to a system and a method for recognizing and tracking an object using an Artificial Intelligence (AI) and autonomous driving sensor, and more particularly, to a system and a method for calibrating a three-dimensional (3D) sensor based on a scene flow network, which is capable of implementing coordinate calibration between an autonomous driving sensor and a vehicle, rather than coordinate calibration between multiple autonomous driving sensors, thereby accurately estimating a position and a posture of a host vehicle based on measurement values of a sensor.

### BACKGROUND

The matters described in this Background section are only for enhancement of understanding of the background of the disclosure, and should not be taken as acknowledgment that they correspond to prior art already known to those skilled in the art.

As an autonomous vehicle is developed and commercialized, cases of using various sensors and artificial intelligence (AI) technologies to support an autonomous driving functions of a vehicle are increasing. For example, a type of an object in front of a vehicle moving, a distance between the object and the vehicle, or a type of an algorithm to be processed by the vehicle depending on situations for the purpose of ensuring safety are considered.

A vehicle may be mounted with high-performance sensors such as Light Detection and Ranging (LiDAR) to recognize a surrounding environment, Radio Detection and Ranging (RADAR) using a radio wave, an ultrasonic sensor, a fisheye camera to capture an image at 360 degrees, a multi-focal lens, or Global Positioning System (GPS).

As measurement results obtained from a plurality of sensors are aggregated, a vehicle having a super sensor may be implemented. In self-driving (autonomous driving), the concept of the super sensor may refer to a technology for more accurately recognizing a surrounding environment by aggregating measurement values from various sensors, instead of relying on an individual sensor, for the convenience or safety of vehicle driving. As the above technology is combined with an information and communications technology (ICT) and a cloud technology, sensors used for autonomous driving and an AI algorithm related to the autonomous driving may be applied not only for a single vehicle, but also to multiple vehicles (a fleet of vehicles), enabling remote data accumulation and AI model training on a centralized server and database, thereby increasing the reliability of sensor-based determinations and achieving an unprecedented level of advancement.

### SUMMARY

The present disclosure has been made to solve the above-mentioned problems.

An example of the present disclosure provides a system and a method for recognizing and tracking an object using an AI (Artificial Intelligence) and autonomous driving sensor. The present disclosure provides a system and a method for calibrating a three-dimensional sensor based on a scene flow network, capable of implementing coordinate calibration between an autonomous driving sensor and a vehicle, rather than coordinate calibration between autonomous driving sensors, thereby accurately estimating a position and a posture of a host vehicle, based on a measurement value of a sensor.

The technical problems to be solved by the present disclosure are not limited to the aforementioned problems, and any other technical problems not mentioned herein will be clearly understood from the following description by those skilled in the art to which the present disclosure pertains.

To solve an entire portion or at least a portion of the technical solution, the present disclosure is implemented in various following examples.

According to the present disclosure, an apparatus of a vehicle may comprise a sensor configured to obtain a plurality of pieces of point data associated with at least one object in a surrounding environment of the vehicle, a memory configured to store the plurality of pieces of point data, and a processor circuit. The processor circuit may be configured to, based on the plurality of pieces of point data, train and execute an artificial intelligence (AI) model to output a scene flow in real time, wherein the scene flow is associated with motion vectors each representing a movement of a point in the plurality of pieces of point data between two consecutive time points. The processor circuit may further perform motion segmentation on the plurality of pieces of point data, wherein at least part of the plurality of pieces of point data is associated with a static object or a dynamic object present in the surrounding environment, extract a representative static object vector by applying a particle filter to the plurality of pieces of point data, wherein the plurality of pieces of point data are temporally and spatially accumulated from the sensor, and adjust coordinates of the sensor using at least one of a roll value of the representative static object vector, a pitch value of the representative static object vector, a yaw value of the representative static object vector, or a height value of the representative static object vector.

The processor circuit may be configured to recognize a point, which is associated with a ground plane, based on the plurality of pieces of point data, estimate initial coordinate-calibration values with respect to a 3 Degrees of Freedom (3-DOF), wherein the 3-DOF may comprise at least one of the roll value, the pitch value, or the height value, and perform a ground plane fitting process for removing the ground plane.

The ground plane fitting process may be performed in parallel with the training and execution of the AI model.

The processor circuit may be configured to execute the AI model to determine, via the sensor, a tilting angle and a height with respect to axes of a three-dimensional coordinate system of the vehicle, determine, based on the tilting angle and the height, the roll value, the pitch value, the yaw value, and the height value, obtain, based on the roll value, the pitch value, the yaw value, and the height value, a scene flow vector, and accumulate and validate the scene flow vector over time to recognize misalignment of a coordinate system of the sensor.

The ground plane fitting process may be performed using an algorithm comprising at least one of Rule-based Random Sample Consensus (RANSAC) or Patchwork++.

The ground plane fitting process may comprise determining a coordinate calibration matrix for the roll value, the pitch value, and the height value, based on a ground plane detected within a threshold distance from the vehicle, wherein the ground plane is perpendicular to a height axis of a coordinate system of the vehicle.

The ground plane may be removed from the plurality of pieces of point data via the ground plane fitting process to obtain a point cloud frame, wherein the training and execution of the AI model may be based on the point cloud frame.

The motion segmentation may be performed based on a number of points associated with the static object being larger than a number of points associated with the dynamic object.

The processor circuit may be configured to classify, as dynamic objects, points having a value exceeding a threshold value, wherein the threshold value is defined based on an average value of scene flow vectors associated with the dynamic objects and static objects, and exclude the points classified as the dynamic objects when selecting the representative static object vector from scene flow vectors associated with the static objects.

The adjustment of coordinates of the sensor may be performed based on the representative static object vector being parallel to a movement vector, wherein the movement vector corresponds to straight-line travel of the vehicle, and wherein the vehicle is mounted with the sensor.

According to the present disclosure, a method performed by an apparatus of a vehicle may comprise obtaining, via a sensor of the vehicle, a plurality of pieces of point data associated with at least one object in a surrounding environment of the vehicle, based on the plurality of pieces of point data, training and executing an artificial intelligence (AI) model to output a scene flow in real time, wherein the scene flow is associated with motion vectors each representing a movement of a point in the plurality of pieces of point data between two time points, performing motion segmentation on the plurality of pieces of point data, wherein at least part of the plurality of pieces of point data is associated with a static object or a dynamic object present in the surrounding environment, extracting a representative static object vector by applying a particle filter to the plurality of pieces of point data, wherein the plurality of pieces of point data are temporally and spatially accumulated from the sensor, and adjusting coordinates of the sensor using at least one of a roll value of the representative static object vector, a pitch value of the representative static object vector, a yaw value of the representative static object vector, or a height value of the representative static object vector.

According to the present disclosure, a vehicle may comprise a sensor, a driving control circuit configured to control autonomous driving of the vehicle, and a processor circuit. The processor circuit may be configured to obtain point cloud data at different time points from the sensor, identify a plurality of static objects based on the point cloud data, compare positional changes of the plurality of static objects between the different time points, determine, based on the comparison of the positional changes, a misalignment between coordinates of the sensor and coordinates of the vehicle, output, based on the misalignment, a signal indicating calibration parameters, wherein the calibration parameters may comprise at least one of a roll value, a pitch value, a yaw value, or a height value, adjust, based on the signal, the coordinates of the sensor such that the coordinates of the sensor are aligned with the coordinates of the vehicle, and control, via the driving control circuit and based on the adjusted coordinates of the sensor, autonomous driving of the vehicle.

The processor circuit may be configured to classify points of the point cloud data obtained at the different time points, wherein the classified points may comprise points corresponding to the plurality of static objects and points corresponding to a plurality of moving objects.

The processor circuit may be configured to extract a static object vector by aggregating motion vectors associated with the plurality of static objects, wherein the motion vectors each represent a movement of a point in the point cloud data between two time points, wherein the plurality of static objects may be obtained from the point cloud data, and wherein the point cloud data may be obtained from different positions of the sensor at the different time points.

The processor circuit may be configured to apply a particle filter to the motion vectors so that the motion vectors converge toward the static object vector.

The processor circuit may be configured to, based on the static object vector, update the calibration parameters in real time during driving of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an overall system to control a vehicle to autonomously recognize an object and perform autonomous driving;

FIG. 2 shows an example of an overall algorithm for calibrating coordinates of a 3D sensor, based on a scene flow;

FIG. 3 shows an example of an overall algorithm for calibrating coordinates of a 3D sensor, based on a scene flow;

FIG. 4 shows an example of an algorithm focusing on a scene flow network of techniques for calibrating 3D coordinates based on a scene flow;

FIG. 5 shows an example of a process for performing ground plane fitting;

FIG. 6 shows an example of a process for training a scene flow network;

FIG. 7 shows an example of a process for performing motion segmentation;

FIG. 8 shows an example of a process for extracting a representative static object vector using a particle filter;

FIG. 9 shows an example of a process for calibrating a LiDAR sensor coordinate;

FIG. 10 shows an example of a process for performing calibration for a roll value, a pitch value, a yaw value, or a z value;

FIG. 11 shows an example of an experiment result obtained by calibrating 3D sensor coordinates, based on scene flow;

FIG. 12 shows an example of an experiment result obtained by calibrating 3D sensor coordinates based on scene flow; and

FIG. 13 shows an example of a computing system for computation to control an autonomous driving vehicle and to calculate an object recognition computation.

### DETAILED DESCRIPTION

Hereinafter, some examples of the present disclosure will be described in detail with reference to accompanying drawings. In the following description, the same reference numerals will be assigned to the same components even though the elements are illustrated in different drawings. In addition, in the following description of an example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, according to the present disclosure, actually, an object has a meaning the same as a meaning of an object. According to the present disclosure, the object and the object may be used together interchangeably.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., a feature of a self-calibrating sensor using scene-flow-based static-object alignment) described herein, an operation of the vehicle may be controlled. For example, when the LiDAR or camera sensor performs self-calibration to correct a misalignment between a sensor coordinate system and a vehicle coordinate system, the autonomous driving control apparatus may dynamically adjust the driving mode or level of autonomy depending on the calibration accuracy. If the calibration confidence value decreases below a threshold (e.g., due to vibration, temperature change, or partial sensor occlusion), the vehicle may automatically reduce the autonomous driving level (e.g., from full autonomy to partial driver assistance) until reliable alignment is reestablished. Conversely, when the calibration accuracy is verified using scene-flow data of static objects (e.g., buildings, poles, or barriers, etc.), higher-level autonomous functions such as automatic lane changing, adaptive cruise control, or emergency braking may be reactivated. In addition, the driving control apparatus may adjust braking timing, acceleration control, or forward collision warning timing according to the updated calibration parameters. For instance, when a recalibrated sensor indicates a more accurate distance to a leading vehicle, the braking control and deceleration control may be optimized to maintain a safe following distance while ensuring smoother autonomous operation.

One or more auxiliary devices (e.g., engine brake, exhaust brake, hydraulic retarder, electric retarder, regenerative brake, etc.) may also be controlled, for example, based on one or more features (e.g., a feature of a self-calibrating sensor using scene-flow-based static-object alignment) described herein. For example, when the vehicle's LiDAR or camera sensor performs real-time coordinate calibration based on scene-flow data of static objects (e.g., buildings, poles, or roadside barriers, etc.), the driving control apparatus may adjust the braking intensity or torque distribution according to the calibration accuracy. When the calibration confidence temporarily decreases due to vibration, fog, or uneven object distribution, the auxiliary braking device (e.g., the regenerative brake or engine brake) may be activated more gradually to maintain vehicle stability. Conversely, when the calibration accuracy is high, stronger regenerative braking may be permitted to optimize energy recovery and maintain precise deceleration control. In addition, when a misalignment of the sensor coordinate system is detected and the calibration process is ongoing, the auxiliary braking devices may cooperate with the traction control system to reduce abrupt braking torque fluctuations caused by inaccurate object distance estimation. This allows smoother braking performance even during self-calibration, thereby enhancing safety and comfort of autonomous driving operation.

One or more communication devices (e.g., a modem, a network adapter, a radio transceiver, an antenna, etc.) that are capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc., may also be controlled, for example, based on one or more features (e.g., a feature of a self-calibrating sensor using scene-flow-based static-object alignment) described herein. For example, when the vehicle's LiDAR or camera sensor performs self-calibration during driving based on scene-flow data obtained from static objects (e.g., buildings, poles, or barriers, etc.), communication parameters of the V2X or cloud connection may be dynamically adjusted according to the calibration status. If the calibration confidence is lower than a threshold, the communication device may transmit calibration status data or diagnostic information to an external server or a remote monitoring system for validation. Conversely, when the calibration is stabilized, the communication bandwidth may be reallocated to transmit perception data or high-accuracy localization information to other vehicles or infrastructure devices. In addition, the communication device may coordinate with nearby vehicles through V2X communication to share static-object alignment data or detected calibration offsets, allowing cooperative perception in multi-vehicle fleets. For instance, when a first vehicle identifies a reliable static-object reference point through scene-flow analysis, the position of that reference point may be broadcast to surrounding vehicles to improve their calibration accuracy. Such cooperative communication control may enhance collective localization reliability and reduce redundant calibration computations among fleet vehicles.

Minimum risk maneuver (MRM) operation(s) may also be controlled, for example, based on one or more features (e.g., a feature of a self-calibrating sensor using scene-flow-based static-object alignment) described herein. For example, when a LiDAR or camera sensor of the vehicle detects a misalignment between its coordinate system and that of the vehicle, and the self-calibration process using scene-flow data of static objects (e.g., buildings, barriers, poles, or signposts, etc.) is being performed, the reliability of surrounding-object recognition may temporarily decrease. In such a case, the driving control apparatus may automatically initiate a minimal risk maneuver (MRM) operation to bring the vehicle into a safer state until accurate calibration is restored. The MRM operation may include gradually decelerating the vehicle, maintaining a stable lateral position within the lane, or steering toward a road shoulder or a safe stop zone detected by the calibrated static-object data. For instance, if the calibration confidence value of the sensor falls below a predetermined threshold during autonomous driving, the vehicle may automatically transition into a controlled deceleration mode and stop in a region identified as free of dynamic obstacles based on the most recent reliable static-object data. Conversely, when the calibration process is successfully completed and the alignment error is reduced, the MRM operation may be deactivated, and the autonomous driving mode may resume. Such calibration-aware MRM control may enhance vehicle safety by ensuring that emergency maneuvers are performed only under conditions where the perception and localization accuracy of the self-calibrating sensor meet or exceed a defined reliability level.

Biased driving operation(s) may also be controlled, for example, based on one or more features (e.g., a feature of a self-calibrating sensor using scene-flow-based static-object alignment) described herein. For example, when the vehicle's LiDAR or camera sensor detects misalignment in its coordinate system relative to the vehicle coordinate system, a self-calibration process may be initiated during driving using scene-flow data obtained from static roadside objects (e.g., buildings, barriers, or poles, etc.). Based on the calibration result, the driving control apparatus may adjust the lateral position of the vehicle within a lane to maintain a stable and accurate perception of lane boundaries. To perform a biased driving control under such conditions, the driving control apparatus may intentionally control the vehicle to maintain a lateral distance that compensates for temporary sensor uncertainty during calibration. For instance, when the alignment confidence of the LiDAR decreases on one side of the vehicle due to partial obstruction or vibration, the system may bias the driving trajectory slightly toward the side with higher calibration reliability to maintain accurate obstacle detection. Similarly, during a lane change or curved-road driving, the vehicle may momentarily adjust its lateral offset to ensure consistent alignment between the sensor coordinate system and the vehicle coordinate system. Such calibration-aware biasing control may improve the vehicle's stability, safety, and performance under real-time driving conditions (e.g., when traveling along narrow roads, near walls, or in tunnels where static objects used for calibration are unevenly distributed).

One or more sensors (e.g., IMU sensors, camera, LiDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., a feature of a self-calibrating sensor using scene-flow-based static-object alignment) described herein. For example, when the LiDAR or camera sensor detects a change in its mounting position or orientation during vehicle operation, the system may automatically perform real-time coordinate calibration based on scene flow data obtained from static objects (e.g., buildings, road barriers, or signposts, etc.) to correct the misalignment. Based on the calibration result, operation parameters of other sensors (e.g., RADAR detection angle, camera field of view, or IMU-based motion compensation) may be adjusted accordingly.

An autonomous driving level and/or autonomous driving activation/deactivation may also be controlled, for example, based on one or more features (e.g., a feature of a self-calibrating sensor using scene-flow-based static-object alignment) described herein. For example, when a misalignment between a coordinate system of a sensor and a coordinate system of a vehicle is detected and corrected in real time using scene-flow data of static objects (e.g., buildings, road signs, or roadside structures, etc.), the reliability of object detection and localization may be evaluated. Based on the evaluated reliability, an autonomous driving level may be dynamically increased, decreased, or temporarily deactivated. A driving control apparatus may perform an autonomous driving level control (e.g., a change of a driving mode from a fully autonomous level to a partially assisted level or to a manual level depending on the calibration confidence) or cause deactivation of an autonomous driving operation. For instance, if the calibration confidence value determined from the scene-flow-based static-object alignment falls below a threshold, the system may request driver intervention or restrict autonomous functions until recalibration is complete. Conversely, when the calibration stability is confirmed, the system may automatically re-enable or upgrade the autonomous driving level.

According to the present disclosure, a scene flow-based calibration technique may be applied to enable a vehicle to automatically recognize and correct misalignment between a three-dimensional (3D) sensor and a vehicle coordinate system. The technique may utilize time-series point cloud data obtained at different time points from a LiDAR or other autonomous driving sensor to identify changes in the appearance of non-moving (static) objects within a surrounding environment. By comparing the positional consistency of such static objects across consecutive frames, the system may determine whether a sensor's orientation or position has shifted relative to the vehicle. When a deviation is detected, calibration parameters including roll, pitch, yaw, and height (z-value) may be estimated and adjusted in real time. Through this process, the vehicle may maintain accurate sensor alignment during driving without requiring a fixed reference structure or separate calibration equipment.

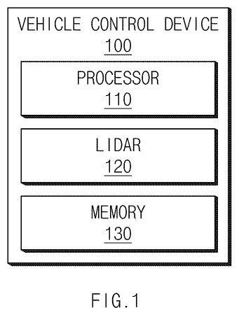

FIG. 1 shows an example of an overall system to control a vehicle to autonomously recognize an object and perform autonomous driving.

Referring to FIG. 1, according to an example, a vehicle control device 100 may be implemented inside or outside a vehicle, and some of components included in the vehicle control device 100 may be implemented inside or outside the vehicle. In this case, the vehicle control device 100 may be formed integrally with internal control units of the vehicle or may be implemented separately from the internal control units of the vehicle to be connected with the internal control units of the vehicle through a separate connector (e.g., a CAN connector, an Ethernet connector, or a wireless communication module such as Bluetooth or Wi-Fi, etc.). For example, the vehicle control device 100 may further include components such as a perception controller, a navigation controller, or a motion planning controller, etc., not illustrated in FIG. 1.

According to an example, the vehicle control device 100 may include a processor 110, a LiDAR 120, and a memory 130. The processor 110, the LiDAR 120, and the memory 130 may be electronically and/or operably coupled with each other through an electronic component including a communication bus.

Hereinafter, the wording “the operably coupling between hardware devices” may include wired and/or wireless establishment of the direct connection between hardware devices and/or the indirect connection between hardware devices, such that a second hardware device is controlled by a first hardware device (e.g., a processor wirelessly controlling a remote sensing unit or a wired connection to an actuator interface, etc.).

Although the hardware devices are illustrated through different blocks, the example is not limited thereto. For example, some of hardware devices in FIG. 1 may be included in a single integrated circuit including a system on a chip (SoC). The type and/or the number of hardware devices included in the vehicle control device 100 is not limited to that illustrated in FIG. 1. For example, the vehicle control device 100 may include some of hardware devices illustrated in FIG. 1 (e.g., a GPS receiver, a communication interface, or a power management circuit, etc.).

According to an example, the vehicle control device 100 may include a hardware device to process data based on at least one instruction. For example, the hardware device to process data may include the processor 110. For example, the hardware device to process data may include an arithmetic and logic unit (ALU), a floating point unit (FPU), a field programmable gate array (FPGA), a central processing unit (CPU), and/or an application processor (AP) (e.g., an ARM-based processor, an Intel x86 processor, or an embedded microcontroller, etc.). The processor 110 may have the architecture of a single-core processor, or may have the architecture of a multi-core processor including a dual-core, a quad-core, a hexa-core, or an octa-core (e.g., an 8-core heterogeneous CPU including high-performance and low-power cores, etc.).

According to an example, the processor 110 may include at least one of a graphic processing unit (GPU), a natural processing unit (NPU), or any combination thereof. For example, a GPU may be referred to as a visual processing unit (VPU) (e.g., an NVIDIA GPU, an AMD GPU, or an integrated Intel GPU, etc.). For example, the NPU may be referred to as a natural network processing unit (e.g., a Tensor Processing Unit (TPU), an AI accelerator, or an edge inference engine, etc.).

According to an example, the vehicle control device 100 may include a depth sensor to detect an external object. For example, the depth sensor to detect the external object may include at least one of a time of flight (ToF) sensor, the LiDAR (light detection and ranging) 120, a structured light sensor, an ultrasonic sensor, an infrared sensor, a radar (radio detection and ranging; RADAR), an optical distance sensor, or any combination thereof (e.g., a stereo-camera pair combined with a millimeter-wave radar, etc.). The following description will be made while focusing on a LiDAR.

According to an example, the vehicle control device 100 may include the LiDAR 120 to obtain a plurality of points, based on a pulse laser signal. For example, the LiDAR 120 may obtain data sets (e.g., representing buildings, pedestrians, lane markings, or roadside signs, etc.) obtained by identifying a surrounding object around the vehicle control device 100 (or a vehicle including the vehicle control device 100). For example, the LiDAR 120 may identify at least one of a position of the surrounding object, the movement direction of the surrounding object, a speed of the surrounding object, or any combination of the surrounding object, based on the pulse laser signal radiated from the LiDAR 120 and reflected back from the surrounding object.

For example, the LiDAR 120 may obtain data sets representing external objects which are present in a space formed by an x-axis, a y-axis, and a z axis, based on the pulse laser signal reflected from the surrounding object (e.g., a vehicle, a tree, a pole, or a pedestrian, etc.). For example, the LiDAR 120 may obtain the data sets including a plurality of points which are present in a space formed by the x-axis, the y-axis, and the z axis, based on the pulse laser signal received with a specific period. For example, the plurality of points may include points representing an external object in a three-dimensional (3D) virtual coordinate system. The 3D virtual coordinate system may include at least one of a vehicle coordinate system, a LiDAR coordinate system, or any combination thereof (e.g., a world coordinate system or a map coordinate system, etc.). However, the example of the 3D virtual coordinate system is not limited to the above description.

According to an example, the memory 130 of the vehicle control device 100 may include a hardware component to store data and/or an instruction input and/or output to and/or from the processor 110 of the vehicle control device 100. For example, the memory 130 may include a volatile memory including a random-access memory (RAM), and/or a non-volatile memory including a read-only memory (ROM) (e.g., a flash-based embedded memory, an SD card, or an SSD, etc.).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), an embedded multi-media card (eMMC), or any combination thereof (e.g., NAND flash modules or NVMe drives, etc.).

The memory 130 of the vehicle control device 100 may store at least one instruction indicating a calculation and/or operation to be performed based on the data by the processor 110 of the vehicle control device 100. The set of the at least one instruction may be referred to as a program, firmware, an operating system, a process, a routine, a sub-routine, and/or an application (e.g., a perception algorithm, a localization module, or a deep-learning inference engine, etc.).

Hereinafter, installing an application inside the vehicle control device 100 refers to that at least one instruction provided in the form of an application is stored in the memory 130. In this case, the at least application may be stored in the format (a file with an extension specified by an operating system of the vehicle control device 100) executable by the processor 110 of the vehicle control device 100 (e.g., an .exe, .bin, or .apk file, etc.).

For example, the memory 130 may include a first neural network model to detect an object. For example, the memory 130 may include a second neural network model to output the type of a plurality of points and/or the score of the plurality of points obtained by the LiDAR 120 (e.g., a semantic segmentation model or an instance segmentation model, etc.).

According to an example, the processor 110 may obtain at least one of a first virtual box for expressing a target object, a first class for representing the type of the target object, or any combination thereof, based on the plurality of points obtained through the LiDAR 120 and the first neural network model stored in the memory 130.

According to an example, the processor 110 may obtain at least one of a first virtual box for expressing a target object, a first class for representing the type of the target object, or any combination thereof, based on inputting the plurality of points in the first neural network model. For example, the first neural network model may include an object detection model (e.g., PointPillars, CenterPoint, or PV-RCNN, etc.). For example, the target object may include an external object positioned within a specific distance from the vehicle control device 100 (or a host vehicle including the vehicle control device 100) (e.g., within 100 m or 200 m, etc.). For example, the target object may include an object identified and continuously tracked by the vehicle control device 100. For example, the type of the target object may include a plurality of types to classify the target object (e.g., vehicles, pedestrians, traffic signs, road boundaries, or vegetation, etc.). For example, the type of the target object may include at least one of a first type for representing a ground plane, a second type for representing a type different from the ground plane, or any combination thereof. However, the type of the target object is not limited to the above description. For example, the type of the target object may include at least one of a third type for representing a person, a fourth type for representing a vehicle, or any combination thereof, but the present disclosure is not limited thereto.

According to an example, the processor 110 may obtain at least one of first partial points corresponding to at least a portion of the target object among the plurality of points, a second class for representing the type of the target object and identified through the first partial points, or any combination thereof, based on the plurality of points and the second neural network (e.g., identifying roof points of a vehicle or head points of a pedestrian, etc.). For example, the second neural network model may include a segmentation model (e.g., RangeNet++, SqueezeSegV3, or SemanticKITTI-based model, etc.).

For example, the second neural network model may include a neural network model for obtaining the type of the plurality of points and the score of the plurality of points (e.g., identifying points corresponding to roads, buildings, pedestrians, or vehicles, etc.).

For example, the processor 110 may obtain first partial points, which correspond to at least a portion of the target object, among the plurality of points, based on inputting the plurality of points to the second neural network model. For example, the processor 110 may identify the type of the plurality of points, based on inputting the plurality of points to the second neural network model (e.g., labeling each point as belonging to a vehicle, tree, guardrail, or pedestrian, etc.). For example, the processor 110 may obtain the first partial points, which correspond to at least a portion of the target object, among the plurality of points, based on the type of each of the plurality of points (e.g., selecting only points belonging to the body of a vehicle while excluding background points, etc.).

According to an example, the processor 110 may perform a first specified algorithm with respect to the plurality of points. For example, the processor 110 may perform the first specified algorithm with respect to the plurality of points, to classify the type of the plurality of points (e.g., using RANSAC, DBSCAN, or K-means clustering, etc.). For example, the processor 110 may classify second partial points, which correspond to a specified type, among the plurality of points. For example, the specified type may include the type for representing the ground plane (e.g., asphalt surface, concrete parking floor, or road shoulder, etc.).

For example, the processor 110 may classify the second partial points corresponding to the specified type, based on performing the first specified algorithm with respect to the plurality of points, and obtain (or identify) first partial points by excluding the second partial points from the plurality of points (e.g., removing ground points to isolate vehicle or obstacle points, etc.).

According to an example, the processor 110 may obtain at least one of a partial class for obtaining a second class, a score of each of the plurality of points, or any combination thereof, based on inputting the plurality of points to the second neural network model. For example, the processor 110 may obtain the partial class, and the score of each of the plurality of points, based on inputting the plurality of points to the second neural network model (e.g., confidence scores such as 0.9 for “vehicle” or 0.7 for “pedestrian,” etc.). For example, the partial class may include classifying each of a plurality of points into an arbitrary type (e.g., car, person, bicycle, or traffic sign, etc.).

For example, the processor 110 may fuse the partial class, the score of each of the plurality of points, and the second partial points (e.g., combining semantic labels, point confidences, and cluster assignments, etc.). For example, the processor 110 may perform clustering based on the fusion of the partial class, the score of each of the plurality of points, and the second partial points (e.g., grouping points representing the same car or pedestrian, etc.). For example, the clustering may include grouping the first partial points corresponding to at least a portion of the target object (e.g., creating a cluster for each detected object instance, etc.).

For example, the processor 110 may obtain a point cloud for generating a second virtual box, based on the first partial points (e.g., collecting 3D coordinates belonging to a detected vehicle or pedestrian, etc.). For example, the processor 110 may obtain the point cloud, based on grouping the first partial points (e.g., merging separate LiDAR frames to create a denser object representation, etc.).

For example, the processor 110 may generate the second virtual box which represents a target object and are different from the first virtual box, based on the point cloud (e.g., generating a refined bounding box that better fits the object's contour, etc.). For example, the second virtual box may include a box including at least a portion of the first partial points (e.g., corners enclosing only the upper body of a pedestrian or the chassis of a vehicle, etc.).

For example, the processor 110 may identify a heading direction for indicating the progressing direction of the target object, based on at least one of the first partial points, a point cloud, or any combination thereof (e.g., determining a vehicle's forward vector, a pedestrian's walking direction, or a cyclist's path, etc.).

For example, the processor 110 may identify the position of the second virtual box in a virtual coordinate system, based on at least one of the first partial points, the point cloud, or any combination thereof (e.g., locating the object in global or local coordinates, etc.). For example, the processor 110 may identify the size of the second virtual box, based on at least one of the first partial points, the point cloud, or any combination thereof (e.g., computing length, width, and height of a vehicle or pedestrian, etc.). For example, the processor 110 may identify the second class, based on at least one of the first partial points, the point cloud, or any combination thereof (e.g., reclassifying the object as a small car, SUV, or truck, etc.). For example, the processor 110 may identify at least one of the heading direction for indicating the direction of progress of the target object, the position of the second virtual box in the virtual coordinate system, the size of the second virtual box, the second class, or any combination thereof, based on at least one of first partial points, the point cloud, or any combination thereof (e.g., a vehicle's forward heading, the centroid position, or the length/width/height of the box, etc.). For example, the processor 110 may identify the heading direction of the bounding box, based on at least one of the first virtual box, the first class, the heading direction of the second virtual box, the position of the second virtual box, the size of the second virtual box, the second class, or any combination thereof (e.g., aligning the heading with a principal axis of the object or a pedestrian's walking vector, etc.). For example, the processor 110 may identify the position of the bounding box in the virtual coordinate system, based on at least one of the first virtual box, the first class, the heading direction of the second virtual box, the position of the second virtual box, the size of the second virtual box, the second class, or any combination thereof (e.g., in a LiDAR frame, a vehicle/body frame, or a world/map frame, etc.). For example, the processor 110 may obtain the third class for representing the type of the target object corresponding to the bounding box, based on at least one of the first virtual box, the first class, the heading direction of the second virtual box, the position of the second virtual box, the size of the second virtual box, the second class, or any combination thereof (e.g., sedan, SUV, truck, or bicyclist, etc.). For example, the processor 110 may obtain the heading direction of the bounding box, the position of the bounding box in the virtual coordinate system, the third class for representing the type of the target object corresponding to the bounding box, or any combination thereof, based on at least one of the first virtual box, the first class, the heading direction of the second virtual box, the position of the second virtual box, the size of the second virtual box, the second class, or any combination thereof (e.g., outputting these values for tracking, planning, or visualization, etc.).

For example, the processor 110 may assign a first identifier to the second virtual box to track the second virtual box (e.g., ID_1 for a specific car or ID_2 for a nearby pedestrian, etc.). For example, the processor 110 may assign a second identifier, which corresponds to the first identifier, to the bounding box (e.g., associating 2D camera detections with corresponding 3D LiDAR boxes, etc.).

For example, the processor 110 may track the bounding box using the second identifier (e.g., maintaining object identity across multiple LiDAR frames, etc.). For example, the processor 110 may track the target object, based on identifying a plurality of bounding boxes, which includes the bounding box assigned with the second identifier, from a plurality of frames (e.g., frame-to-frame tracking of vehicles, cyclists, or pedestrians, etc.). For example, the second identifier is assigned to the bounding box corresponding to the target object. Accordingly, the processor 110 may track the target object, by identifying a plurality of bounding boxes assigned with the second identifier, from the plurality of frames (e.g., building a trajectory history for each tracked object, etc.).

According to an example, the processor 110 may output the bounding box corresponding to the target object, based on at least one of the first virtual box, the first class, the first partial points, the second class, or any combination thereof (e.g., outputting final detection results to an autonomous-driving planner or visualization interface, etc.). For example, the bounding box may include an example of representing the target object in the form of a hexahedron, on a virtual coordinate system e.g., 3D box enclosing a car, person, or barrier, etc.).

Hereinafter, operations performed by a CPU, a GPU, and/or an NPU included in the processor 110 will be described (e.g., how computational tasks are distributed for real-time perception, etc.).

According to an example, the processor 110 may include at least one of the CPU, the GPU, the NPU, or any combination thereof. For example, the at least one of the CPU, the GPU, the NPU, or any combination thereof may obtain the first virtual box and the first class, based on the first neural network model (e.g., using GPU-accelerated convolutional layers for object detection, etc.). For example, the at least one of the GPU or the NPU may obtain the first virtual box and the first class (e.g., executing a 3D deep-learning model such as VoxelNet or PointRCNN, etc.). For example, the at least one of the CPU, the GPU, the NPU, or any combination thereof may obtain the score of each of the partial class and the plurality of points to obtain the second class, based on the second neural network model (e.g., applying softmax scoring or feature fusion, etc.). For example, the at least one of the GPU or the NPU may obtain the score of each of the partial class and the plurality of points to obtain the second class, based on the second neural network model. For example, the CPU may classify the second partial points, which correspond to the specific type, of the plurality of points, based on performing the first specific algorithm, which is for classifying a type of each of the plurality of points, with respect to the plurality of points (e.g., ground segmentation or clustering using traditional algorithms, etc.).

As described above, according to an example, the vehicle control device 100 may include at least one processor 110. The vehicle control device 100 may accurately detect the target object by detecting the target object using at least one processor 110 (e.g., identifying and tracking cars, people, bicycles, or road obstacles, etc.). In addition, the vehicle control device 100 may reduce the load on each processor, by performing a parallel process (e.g., distributing inference tasks across multiple GPU cores or NPUs, etc.).

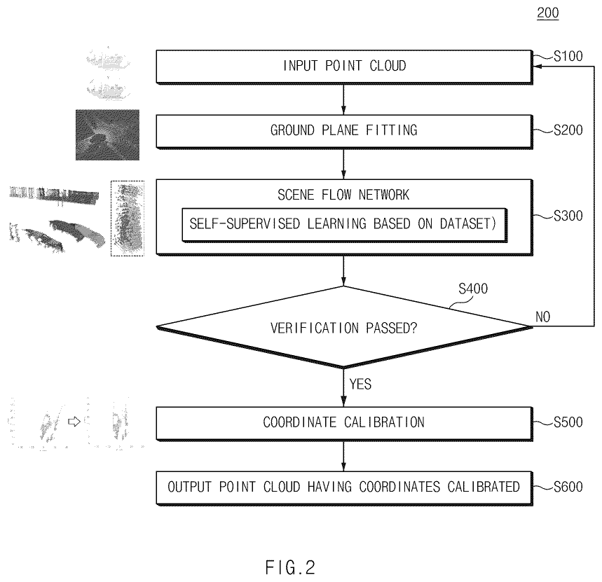

Meanwhile, before the description made with reference to FIG. 2, the recognition of a LiDAR-based object will be additionally described, for the overall comprehension about the recognition of the AI object.

An object recognition process by the LiDAR 120 and the AI module is performed through three steps for performing a pre-processing step, a segmentation step, and a tracking step. For example, AI module may include and execute one or more AI models (e.g., neural networks) for the pre-processing, segmentation, and tracking (e.g., detecting road surfaces, identifying vehicle outlines, or following pedestrian movement, etc.).

A system 1000 for recognizing the object according to the present disclosure undergoes a pre-processing procedure before performing an object recognition function. The pre-processing process may include an operation for removing, for example, points forming the ground plane, based on laser sensing data (that is, unprocessed raw data) input from the LiDAR 120 (e.g., removing asphalt, road surface, or floor points, etc.). A certain object may be misrecognized as being present even on the ground plane by a laser beam reflected from the ground plane. Accordingly, a process for distinguishing between the ground plane and things other than the ground plane is performed in the pre-processing step. If necessary, the process for distinguishing between the ground plane and the things (e.g., curbs, vehicles, or roadside structures, etc.) other than the ground plane may be performed even in the segmentation step.

For example, in recognizing the AI object, the pre-processing process may be understood as a process for removing noise from a LiDAR point cloud image and reducing the total number of points, which are present in the LiDAR point cloud image, for example, through a voxel downsampling technique (e.g., uniform grid-based downsampling, statistical outlier removal, or radius filtering, etc.), by an image processing tool of an AI module which is provided in the process 110, thereby enhancing computational efficiency.

For reference, the LiDAR point cloud image may be expressed in a Bird's Eye View (BEV) format. The LiDAR map is formed to look like a scene viewed from eyes of a bird flying over an urban area (e.g., highways, intersections, or parking lots, etc.). In this case, the LiDAR map is referred to as a BEV image.

In other words, the LiDAR 120 transmits a laser beam to a surrounding environment and records a time at which each laser beam is reflected from an external object and returned, thereby forming a point for each of numerous laser signals and calculating the distance to the point, as described above. In such a manner that, as the numerous laser beams are repeatedly transmitted, the processor 110 may generate a real-time LiDAR map for the surrounding environment in the form of a 3D map in the BEV format or a two dimensional (2D) map if necessary (e.g., for path planning or localization display, etc.).

A line or a surface in black and white on the LiDAR point cloud image actually includes numerous points (each point is generated by the laser beam of the LiDAR 120). Accordingly, a LiDAR sensing image is referred to as the LiDAR point cloud image. In addition, when an RGB-D (Red, Green, Blue-Depth) sensor and the LiDAR sensor are combined, the LiDAR point cloud image may be realized as a colored image (e.g., adding color information to visualize buildings, vehicles, and pedestrians, etc.).

A human being may find it difficult to recognize a thing only using individually each of numerous points in the LiDAR point cloud image. However, for example, the human being may substantially guess a situation of a surrounding environment of the vehicle during the autonomous driving, when totally considering the point cloud through a manner such as the BEV format or a 2-D plan view. Further, for example, a vehicle, a bus, a pedestrian, a roadside tree, or a traffic sign, which is present in the LiDAR point cloud image, may be recognized (e.g., as clusters or bounding boxes corresponding to known object categories, etc.). According to the AI image recognizing technology, such a thing or a person may be referred to as an object, and may be classified into a class, such as a vehicle class, or a bus class, which belongs to a group having a specific characteristic for each object (e.g., based on shape, reflectivity, or motion pattern, etc.).

To identify an object belonging to the vehicle class or the bus class in the LiDAR point cloud image, the help of a deep AI neural network is required. AI training needs to be preceded to find objects in the LiDAR point cloud image and identify the class for the object through the AI neural network (e.g., using supervised datasets with annotated bounding boxes and semantic labels, etc.).

For example, a dataset called PANDASET™ contains over 48,000 camera images (mainly images taken in the Silicon Valley area of the United States) and over 16,000 LiDAR scan images. The above images have 28 classes in the form of annotations, in which the 28 classes include a pedestrian, a passenger car, a bicycle, a construction site sign, and a traffic sign (e.g., traffic lights, barricades, or motorcycles, etc.).

In addition, the LiDAR point cloud image may be visualized to meet an option desired by a user through a point cloud work tool such as Open3DTM. The LiDAR 120 is able to detect a distance. Accordingly, for example, the LiDAR 120 may reproduce the 3D LiDAR image to be more realistically, by expressing a thing, which is present at a longer distance, in deep blue color, or a thing, which is present at a shorter distance, in light blue in visualizing in Open3D™ (e.g., blue-to-yellow depth gradients or intensity-based color mapping, etc.).

In addition, as described above, an original LiDAR image (that is, Raw Data) may be pre-processed by applying a technology called Voxel (3D pixel) downsampling to the LiDAR point cloud image. In this case, Voxel refers to a cube-shaped 3D pixel, and Voxel downsampling is a technology for reducing the number of points to prevent excessive AI operations while maintaining the structure of various objects included in the LiDAR point cloud (e.g., reducing millions of raw points to tens of thousands while preserving car or pedestrian contours, etc.).

Meanwhile, the LiDAR 120 irradiates, for example, ‘m’ laser beams ‘n’ times during one scan cycle. In this case, the scan value of the laser beam, which collides with the external object and returns, forms a (m×n) matrix, which is called a range image. Each point forming the LiDAR point cloud image includes depth information (that is, a range), and further includes an intensity, an azimuth, an inclination, and other additional data of the returned laser pulse (e.g., reflectivity, timestamp, or beam ID, etc.). Regarding range images, AI learning is possible using a large number of datasets such as Waymo™ Open Dataset (WOD) (e.g., including annotated 3D boxes for cars, cyclists, and pedestrians, etc.).

Range View (RV) is a technique which transforms a 3D point cloud into a 2D or 2.5D scene and expresses the 3D point cloud as a LiDAR 3D map, such as an analog picture, intuitively understood by a human being. The 3D LiDAR point cloud image has 2D coordinates in the range view. However, the 3D laser-related information (an angle, a slope, or an intensity) recorded when obtaining the range image is not discarded. Coordinates on one axis in 2D are obtained by applying a variable of a width to (x, y) coordinates of the (x, y, z) coordinate values of the 3D LiDAR image, and coordinates on another axis in 2D are obtained by applying range image information, which represents a range (depth), and a variable of a height to a (z) coordinate, thereby making a 2D range view image (e.g., converting point-cloud data into a 360° panoramic projection for easier processing by neural networks, etc.).

In addition, the AI algorithm according to the present disclosure may include a convolutional neural network (CNN). The CNN is an AI training module often employed to extract a feature (or a feature point) from the image data (e.g., identifying object edges, shapes, or depth transitions, etc.). To this end, a dataset of tens of thousands of commercially available images is present. Currently, CNN has versions which may process images from 1D to 3D. In other words, the results of the range view image processing tool are learned by the CNN neural network to help AI accurately recognize objects in the image (e.g., detecting vehicles, pedestrians, or traffic signs within the projected range image, etc.).

Since an object around an autonomous vehicle is recognized by machine, an operation for generating a GT Bounding Box on a LiDAR map, which is described above, is an important process for recognizing the object. In machine learning, ground truth (GT) is a term used to indicate a source to a real value of data to be trained by AI. The GT bounding box, which is a bounding box having a box-type boundary, may be a kind of an image annotation applied to the LiDAR point cloud image (e.g., a labeled 3D box enclosing a vehicle or pedestrian used for supervised training, etc.).

Various objects are grouped using labels such that the AI module recognizes an object. In addition, the distance is set between the 3D data points used to output the GT bounding box. In this case, one GT bounding box may be configured to include 50 LiDAR cloud points to 1,000 LiDAR cloud points (e.g., denser clusters for nearby vehicles and sparser ones for distant pedestrians, etc.).

In this case, the GT annotation is absent in the raw data, which is captured by a sensor, such as the LiDAR 120, during the vehicle driving. The processor 110 recognizes a target, which belongs to various classes such as a road sign, a crosswalk, a pedestrian, another vehicle, or a central line, as an object. The GT annotation is used to measure an object recognition error by comparing a recognition result, which is determined as an object through the AI algorithm, with a real object and to evaluate AI performance (e.g., by calculating mean average precision or Intersection-over-Union, etc.). The GT bounding box, which is applied to the source image, in the form of an annotation may be manually set by a user. However, a representative commercial GT calculation tool, such as Grid-striding, may be used (e.g., for automated labeling of large datasets, etc.).

Meanwhile, when an AI object recognition module is driven, a prediction bounding box may be recognized. A result recognized by the processor 110 as an object belonging to a specific class based on source image data obtained from the LiDAR 120 is represented in the form of another bounding box which is similar to the GT bounding box (e.g., predicted by a trained neural network such as PointPillars or PV-RCNN, etc.). The prediction bounding boxes are computation results of the autonomous driving AI, which is different from the GT bounding box. The prediction bounding box may be matched with the GT bounding box. However, the prediction bounding box fails to be matched with the GT bounding box, or may have no overlap region with the GT bounding box (e.g., due to occlusion, low point density, or misclassification, etc.).

For reference, an object, which belongs to a specific class, may not be determined as actually existing at a certain position only using the prediction bounding boxes. Accordingly, the prediction bounding boxes are substantially referred to as a probability box (P-BOX) or a predicted bounding box (e.g., indicating that each box has an associated confidence score, such as 0.8 for vehicle or 0.4 for pedestrian, etc.).

The segmentation step performed after the pre-processing step refers to, for example, expressing a specific part of a road (for example, a traffic light), for example, in red, and expressing a reaming portion (an asphalt road) of the road in blue. In the segmentation step, point clouds are clustered in a specific group, and a P-Box is generated. For reference, there is a technology of cluster expansion. According to the cluster expansion technology, the target of the expansion may include a cluster of all points, which includes a seed point, within an epsilon (the minimum distance for forming the cluster) distance (e.g., similar to density-based algorithms such as DBSCAN, etc.).

In the segmentation step, clustering and P-Box generating are performed, based on the point cloud. For example, the AI network to perform the segmentation step is used to obtain a point label from the LiDAR 120 (e.g., labeling each point as “road,” “vehicle,” “pedestrian,” or “vegetation,” etc.).

According to the present disclosure, to solve the ground plane recognition error caused in the segmentation step, a “rule-based” road surface recognition technique and a label fusion technique are suggested. An algorithm (hereinafter, a rule-based algorithm) for the rule-based road surface recognition technique may typically employ any of a variety of techniques, such as a slope-based road surface recognition technique, a grid-based road surface recognition technique, and other non-planar-based road surface recognition techniques (e.g., curvature-based detection on uneven surfaces, etc.). However, according to the present disclosure, the slope-based road recognition technique should be employed when the road surface is recognized inside a tunnel (e.g., where grid-based techniques are unreliable due to ceiling reflections, etc.).

For reference, the semantic segmentation technique is a work for attaching an intrinsic class label to each point in the point cloud generated by the LiDAR 120. The semantic segmentation in the LiDAR image processing technology is a technology which finds and uses meaningful information from LiDAR data for object recognition or scene reproduction required to implement autonomous driving. Various semantic segmentation AI models including a projection-based method, a point-based method, and a sporadic convolution-based method may be provided (e.g., SqueezeSeg, PointNet++, or SparseConvNet, etc.). For example, the result of the semantic segmentation may be the result of an AI operation performed by the processor 110 together an NVIDIA DRIVE™ AGX system. Accordingly, such a configuration may apply various colors to, for example, the LiDAR point cloud image (e.g., coloring vehicles in red, pedestrians in yellow, and road surfaces in gray, etc.).

The LiDAR image undergoes a post-processing procedure after the segmentation step as described above. The post-processing procedure refers to the transformation of point cloud data into a 3D map or modeling, which is information meaningful for autonomous driving. The post-processing procedure also includes the process for finally removing noise or errors from the LiDAR point cloud image, for recognizing an object, such as a vehicle or a pedestrian, from the point cloud, and attaching an intrinsic identifier to the point cloud information if necessary such that the point cloud information is registered (e.g., assigning track IDs, updating temporal maps, or aligning with vehicle odometry, etc.).

FIG. 2 shows an example of an overall algorithm 200 for calibrating coordinates of a 3D sensor, based on a scene flow, according to an example of the present disclosure.

Referring to FIG. 2, in ‘S100’, point cloud data is input from the autonomous driving sensor (or LiDAR) 120. According to an example, since the scene flow is used, even the point cloud data is configured with time points ‘T’ and ‘T+1’ for time-series inputs (e.g., consecutive LiDAR frames captured at 0.1-second intervals, etc.).

In ‘S200’, ground plane fitting may be performed. A rule-based algorithm may be applied to the ground plane fitting. An algorithm such as Random Sample Consensus (RANSAC) or Patchwork++ may be employed as a ground plane recognition algorithm (e.g., RANSAC for highway roads or Patchwork++ for urban or sloped terrains, etc.). The sensor calculates a tilting angle and a height with respect to an x axis or a y axis to find a roll value, a pitch value, a height value (z value). In ‘S200’, the point cloud data having no point for the ground plane is used as an input of the scene flow network.

In ‘S300’, the scene flow network is operated. The sensor calculates the tilting angle (yaw value) with respect to the z axis, and accumulates and validates extracted scene flow vectors over time to recognize the misalignment of a coordinate system. In addition, the sensor calculates the titling angle and the height (a roll value, a pitch value, a yaw value, or a z value) for the x-axis, y-axis, and z axis, and accumulates and validates the extracted scene flow vectors over time to recognize the misalignment of the coordinate system (e.g., determining if the LiDAR orientation drifts due to vibration or mounting shifts, etc.).

Regarding the scene flow network, it should be noticed that the scene flow network is operated to perform pseudo labeling and to be trained through a self-supervised learning manner, by utilizing an HMC RS4 dataset (e.g., fine-tuning using unlabeled driving data sequences with temporal consistency constraints, etc.).

Thereafter, in ‘S400’, the validation may be performed and passed. In this case, ‘S500’ is performed to calibrate coordinates. In ‘S600’, the point cloud having coordinates calibrated is output (e.g., the corrected 3D points are projected into the vehicle coordinate frame for mapping or object tracking, etc.).

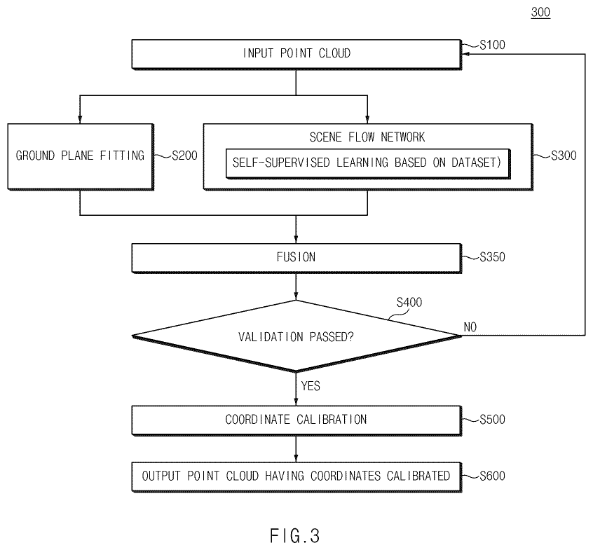

FIG. 3 shows an example of an overall algorithm 300 for calibrating coordinates of a 3D sensor, based on a scene flow, according to another example of the present disclosure. An algorithm 300 is FIG. 3 is significantly similar to the algorithm 200 in FIG. 2, except that ‘S200’ and ‘S300’ are performed in parallel (e.g., concurrent ground-plane fitting and scene-flow estimation for faster real-time processing, etc.).

Referring to FIG. 3, the point cloud is input in ‘S100’, which is similar to FIG. 2, and a ground plane fitting is performed in ‘S200’. The ground plane point is recognized to estimate a calibrated coordinate value for the 3-DOF (a roll value, a pitch value, and a z value) (e.g., compensating for uneven road inclines or tilted sensor mounts, etc.).

Further, in S300, the learning (training) of the scene flow network, which outputs the scene flow and is operable in a real time, is performed based on a LiDAR sensor input value in ‘S100’. Thereafter, motion segmentation is performed with respect to all points including static objects or dynamic objects, and the representative static object vector is extracted from a temporal or spatial accumulation of the point cloud sequence by applying a particle filter. Subsequently, the roll value, the pitch value, the yaw value, and the z-value of the representative static object vector are estimated (e.g., averaging static object motion vectors from buildings or poles to infer LiDAR misalignment, etc.).

In ‘S350’, the result in ‘S200’ and the result in ‘S300’ are fused, and a weighting filter is applied based on the number of ground plane points, the reliability, or the number of static objects (e.g., assigning higher weight to stable ground-plane data when dynamic motion is detected, etc.). Thereafter, in ‘S400’, the validation may be performed, if the validation is passed, ‘S500’ is performed to calibrate coordinates. In ‘S600’, the point cloud having coordinates calibrated is output (e.g., aligned for downstream tasks such as localization or 3D object tracking, etc.).

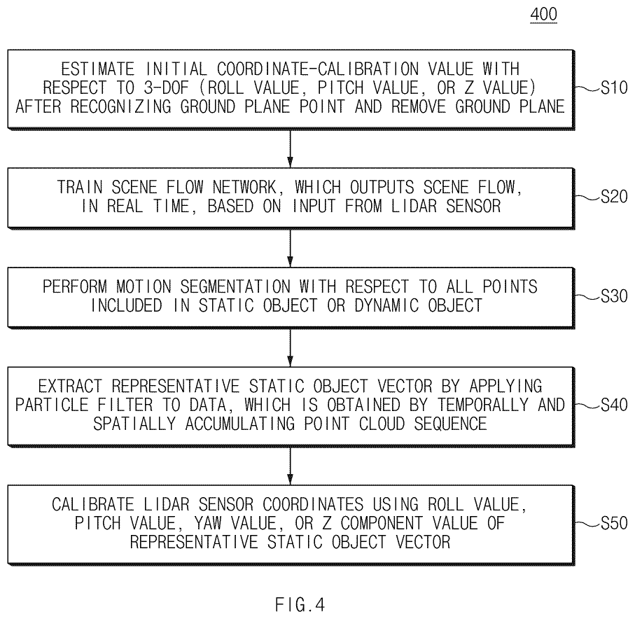

FIG. 4 shows an example of an algorithm 400 focusing on a scene flow network of techniques for calibrating 3D coordinates based on the scene flow, according to an example of the present disclosure.

For example, as illustrated in FIG. 4, it may be understood that ‘S10’ is configured to correspond to the rule-based algorithm, and ‘S20’ to ‘S50’ are configured based on the AI network. For reference, the present disclosure is changed in design to be driven only through an AI network except for ‘S10’ in FIG. 4 (e.g., replacing traditional plane-fitting logic with end-to-end deep learning models for real-time calibration, etc.).

Referring to FIG. 4, in ‘S10’, the ground plane point is recognized, which is similar to ‘S200’ of FIGS. 2 and 3, Thereafter, initial coordinate-calibration values are estimated with respect to the 3-DOF (a roll value, a pitch value, or a z value) and the ground plane is removed. This process may be performed by the rule-based algorithm, and may be omitted if necessary (e.g., when pre-calibrated mounting data is available from prior sessions, etc.).

In S20, the real-time scene flow network to output the scene flow is trained (see ‘S300’ of FIGS. 2 and 3) based on the input from the LiDAR 120. In ‘S30’, the motion segmentation manner is performed with respect to all points including the static object and the dynamic object (e.g., separating buildings, poles, and road surfaces from moving entities such as vehicles or pedestrians, etc.).

In ‘S40’, a representative static object vector is extracted by applying a particle filter to data, which is obtained by temporally (e.g., at different time points) and spatially (e.g., from different positions of the LiDAR sensor) accumulating a point cloud sequence (e.g., filtering and averaging vectors from multiple consecutive LiDAR frames to stabilize calibration accuracy, etc.). In ‘S50’, the coordinate system of the LiDAR sensor is calibrated using the roll value, the pitch value, the yaw value, or the z axis value of the representative static object vector (e.g., adjusting sensor orientation to maintain alignment with the vehicle frame even after vibration or mechanical drift, etc.).

As described above, the present disclosure may be implemented (i) by grafting the scene flow network to the rule-based algorithm of FIG. 2, (ii) by performing the rule-based algorithm and the scene flow network in parallel and fusing the rule-based algorithm and the scene flow network, as illustrated in FIG. 3, and (iii) by using only a network except for ‘S10’, as illustrated in FIG. 4 (e.g., an end-to-end AI calibration approach without explicit ground-plane fitting, etc.).

It may be understood that the above three methods are varied depending on whether to use the rule-based algorithm when finding a total of six DOFs (Degrees of Freedom) of (x, y, z) coordinates, a roll value, a pitch value, and a yaw value. According to (i), the rule-based algorithm refers to a ground plane fitting procedure. In other words, the network need not be trained in a process for finding the ground plane (the roll value, the pitch value, and the z value). According to the present disclosure, the ground plane fitting procedure is implemented through a RANSAC algorithm, thereby maximizing the performance (e.g., robustly detecting planar regions even under noisy point clouds, etc.). In this case, the yaw value is calculated through the rule-based algorithm. Accordingly, the yaw value has a greater error. Accordingly, the present disclosure is implemented using the scene flow network to improve yaw estimation (e.g., correcting rotational drift from vehicle turns, etc.).

According to (ii), the present disclosure is configured by performing the rule-based algorithm and the scene flow network in parallel. The advantages and disadvantages may be appropriately supplemented by adjusting the weight of each logic for various conditions (e.g., the number of ground points, the number of static objects, the reliability of an algorithm, or environmental noise level, etc.).

Finally, (iii) is performed on the assumption that the roll value, the pitch value, or the z value (e.g., a height value) are sufficiently calculated using the scene flow network (e.g., when the neural network has been trained with diverse terrain data and achieves sub-degree orientation accuracy, etc.).

For reference, the rule-based algorithm improves a computation speed, makes tuning of ground plane fitting easier than AI-based hyper-parameter tuning, and does not require any learning process (e.g., immediately usable for on-the-fly calibration without model retraining, etc.).

In contrast, an algorithm based only on a network do not require any prior conditions (for example, there is no constraint that the ground plane needs to be flat), When applied to various vehicle types, the algorithm does not require additional tuning, as long as only the learning data is obtained (e.g., applicable to sedans, SUVs, or trucks without parameter reconfiguration, etc.).

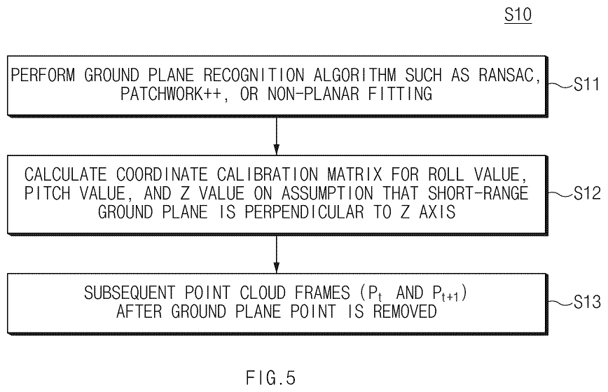

FIG. 5 shows an example of a process for performing the ground plane fitting, according to an example of the present disclosure. In other words, FIG. 5 is a detailed flowchart of ‘S10’ in FIG. 4.

Referring to FIG. 5, in ‘S11’, the ground plane recognition algorithm, such as RANSAC, Patchwork++, or Non-Planar fitting, is applied. In ‘S12’, a coordinate calibration matrix for a roll value, a pitch value, and a z value is calculated on the assumption that the short-range ground plane is perpendicular to the z axis. In ‘S13’, the subsequent point cloud frames (Pₜ and Pₜ₊₁) is obtained after the ground plane point is removed (e.g., retaining only above-ground features like buildings, guardrails, or vehicles, etc.).

In addition, on the assumption that the ground plane is flat in FIG. 5, a normal vector of the ground plane is the same as a normal vector of the vehicle. When the normal vector of the vehicle is found by recognizing a ground plane point and finding the normal vector of the ground plane, a roll (x-axis rotation) value, a pitch (y-axis rotation) value, and a z (sensor position) value in the 6-DOF of the vehicle may be estimated. When considering that the coordinate systems between the sensor and the vehicle are perfectly matched with each other, the coordinate calibration matrix for the roll value, the pitch value, and the z axis may be obtained, because the ground pane at a short distance around the vehicle needs to be perpendicular to a z axis facing sky. In addition, the utilization of the ground plane point is finished. Accordingly, removing the ground plane point from a scene to be analyzed (Scene) is an entire process of ‘S10’ (e.g., preventing ground reflections from affecting motion estimation in later steps, etc.).

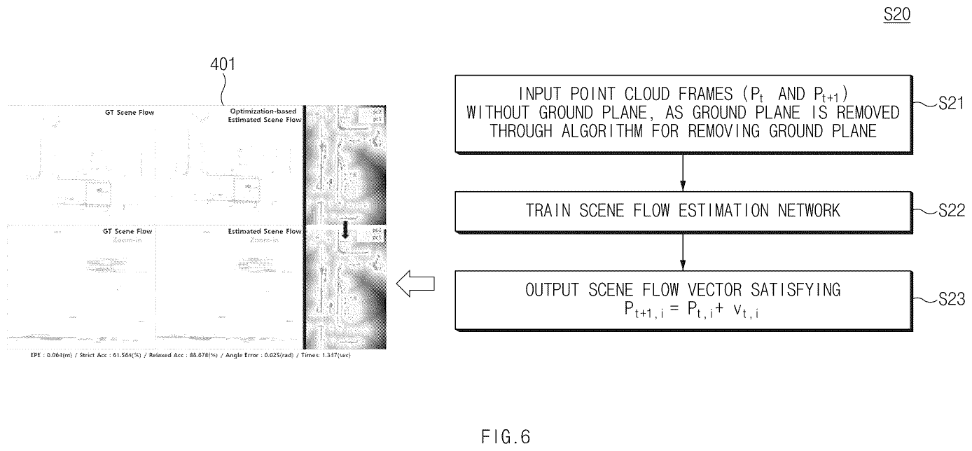

FIG. 6 shows an example of a process for training the scene flow network, according to an example of the present disclosure. In other words, FIG. 6 is a detailed flowchart of ‘S20’ of FIG. 4.

Referring to FIG. 6, in ‘S20’, a scene flow network, which is operable in real time to output a scene flow based on the input value of the LiDAR sensor, is trained. In ‘S21’, point cloud frames (Pₜ and Pₜ₊₁) are input without the ground plane, as the ground plane is removed through the algorithm for removing the ground plane in ‘S10’. In ‘S22’, a scene flow estimation network is trained. In ‘S23’, a scene flow vector satisfying Pₜ₊₁, i=P_{t,i}+V_{t,i} is output. Referring to FIG. 6, reference numeral ‘401’ indicates “Zero Flow: Scalable Scene Flow via Distillation” (e.g., a network architecture leveraging teacher-student learning to reduce computational cost, etc.).

In the state that the coordinate calibration matrix for the roll value, the pitch value, and the z value are found, the x value and the y value among the x value (sensor position), the y value (sensor position), or the yaw value (z axis rotation) remaining in the 6-DOF are failed to be estimated theoretically unless a portion of the vehicle is not recognized by the sensor. In this case, the x value and the y value are less influenced by errors, and thus neglected. Accordingly, the coordinate calibration for the x value and the y value may be performed. Accordingly, the relative movement of a structure (a static object), such as a building, is revers to the movement of the host vehicle. Accordingly, the odometry of the host vehicle may be estimated from the scene flow (e.g., calculating vehicle trajectory and displacement based on static-object motion vectors, etc.).

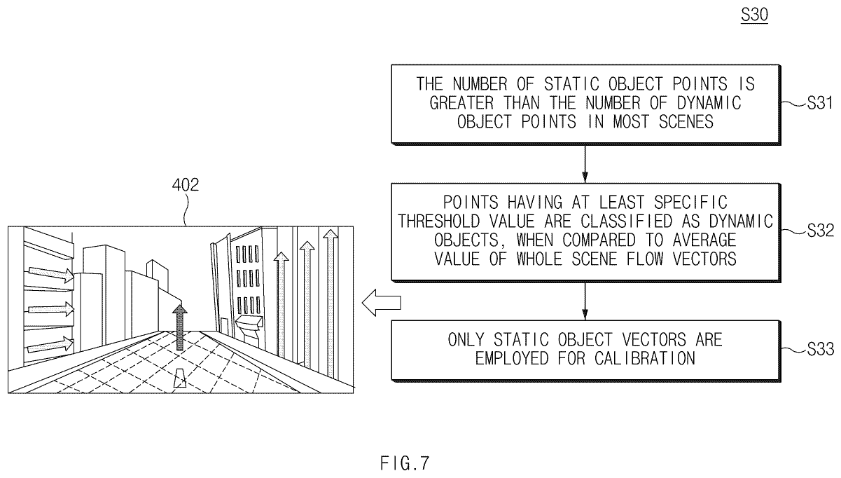

FIG. 7 shows an example of a process for performing motion segmentation, according to an example of the present disclosure. In other words, FIG. 7 is a detailed flowchart of ‘S30’ of FIG. 4.

Referring to FIG. 7, in ‘S31’, it is recognized that the number of static object points is greater than the number of dynamic object points in most scenes (e.g., roadside structures, poles, and buildings generally outnumber moving vehicles or pedestrians, etc.). In ‘S32’, points, which have at least a specific threshold value when compared to an average value of the whole scene flow vectors, are classified as dynamic objects. Thereafter, in ‘S33’, only the static object vector is employed for the coordinate calibration (e.g., filtering out motion of cars or pedestrians and retaining building edges or traffic poles for stable calibration, etc.). In FIG. 7, a self-supervised LiDAR Scene Flow and motion segmentation (SLIM) technique may be employed.

In other words, on the assumption that the movement of the host vehicle is estimated through the scene flow (that is, movement) of the static object or the dynamic object, only the scene flow for the static object is focused. In general situation, when compared to the points of the dynamic object, the static object has considerably many points, even if the ground plane is excluded. Accordingly, when compared to the average of the whole scene flow vectors, points, which have at least the specific threshold value, may be points of the dynamic object. Accordingly, the points of the dynamic point are removed from ‘S33’. For reference, in FIG. 7, reference numeral 402 indicates that the host vehicle advances from the center, the movement of the host vehicle may be estimated using a vector of a building which is a static object (e.g., opposite-direction displacement of a wall or storefront facade while the vehicle moves forward, etc.).

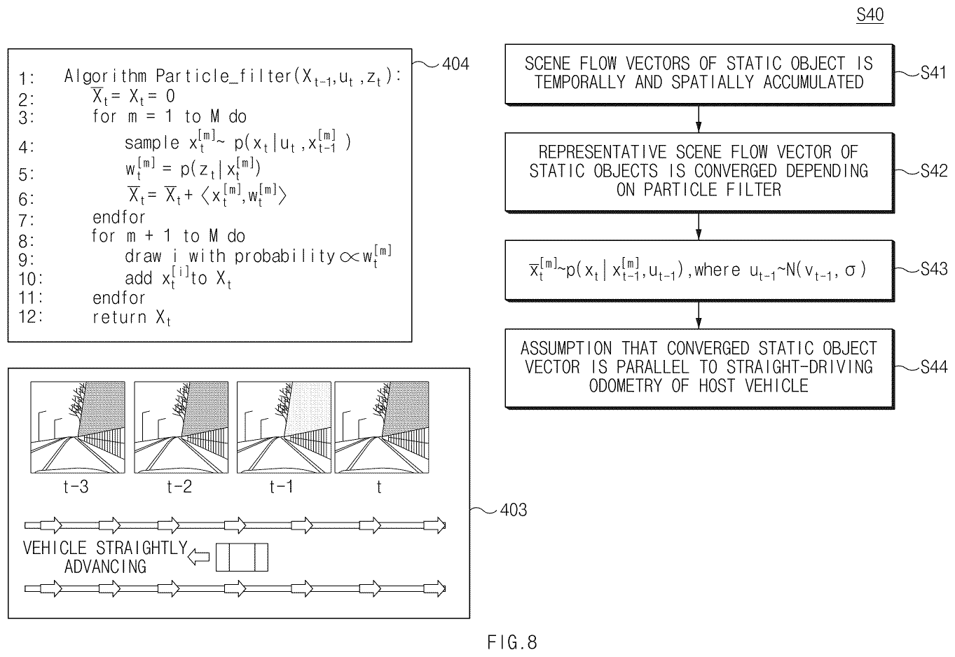

FIG. 8 shows an example of a process for extracting the representative static object vector using the particle filter, according to an example of the present disclosure. In other words, FIG. 8 is a detailed flowchart of ‘S40’ of FIG. 4.

Referring to FIG. 8, in ‘S41’, the scene flow vector of the static object is accumulated temporally and spatially (e.g., combining static-point data over several consecutive LiDAR frames to smooth short-term fluctuations, etc.). In ‘S42’, the representative scene flow vector of the static object is converged depending on the particle filter. In ‘S43’, the following equation 1 is applied. In ‘S44’, the assumption that the converged static object vector is parallel to a straight-driving odometry of the host vehicle is applied.

$${\overline{x}}_{t}^{[ m ]} ∼ p ( {x}_{t} \vert {x}_{t - 1}^{[ m ]} , {u}_{t - 1} ) , where {u}_{t - 1} ∼ N ( {v}_{t - 1} , σ ) \qquad Equation 1$$

In FIG. 8, reference numeral 403 shows that a vector converged for each space is obtained by applying a particle filter to the distribution of the scene flow vectors which are obtained for a specific time, after retaining only the scene flow vector, which corresponds to a static object with higher probability, through the motion segmentation. Regarding the vector converged for each space, a specific vector is obtained in a specific section for a specific time, which indicates, for example, that constant scene flow vector may be obtained in regions at the left and right edges of a road, when a vehicle travels straight in a first lane for 10 seconds (e.g., consistent directional flow along curbside fences or barrier walls, etc.).

Under exceptional situations where a certain structure is repeatedly passed while constantly rolling for a specific time, or where other big objects (buses) pass by the host vehicle at a constant speed on opposite sides of the host vehicle, in the state that the host vehicle is stop for the specific time, convergence may be made to the static object vector. However, when an acceleration sensor is utilized together with respect to the movement of the host vehicle, the exceptional situations may be easily excluded (e.g., acceleration data confirming that the host vehicle is stationary while external motion is detected, etc.).

Reference numeral 404 of FIG. 8 shows examples of codes of the particle filter. Referring to reference numeral 404, xₜ₋₁ indicates the set of particles at a time point of ‘t−1’, uₜ₋₁ indicates a scene flow vector at the time point of ‘t−1’, and Zₜ₋₁ indicates a point input at a time point of ‘t−1’. Referring to reference numeral 404, the average \hat{V}ₜ (that is, the average of K sequences) of the scene flow vector matched with xₜ is determined (e.g., averaging thousands of static-object particles distributed across the LiDAR field of view, etc.).

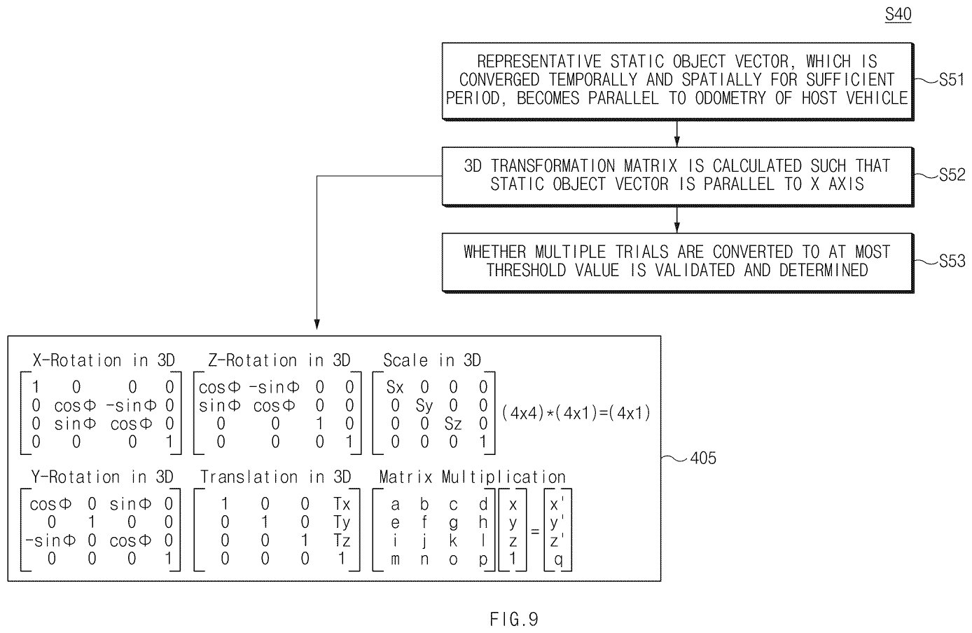

FIG. 9 shows an example of a process for calibrating a LiDAR sensor coordinate, according to an example of the present disclosure. In other words, FIG. 9 is a detailed flowchart of ‘S50’ of FIG. 4.

Referring to FIG. 9, in ‘S1’, it is recognized that a representative static object vector, which is converged temporally and spatially for a sufficient period, becomes parallel to the odometry of the host vehicle which is in a straight-driving situation. In step ‘S52’, a 3D transformation matrix is calculated such that the static object vector is parallel to the x axis. In step ‘S53’, whether multiple trials are converted to at most a threshold value is validated and determined. In FIG. 9, reference numeral 405 illustratively indicates a 3D transformation matrix expressed in the form of a 4×4 matrix (e.g., a homogeneous transformation matrix defining translation and rotation between LiDAR and vehicle coordinate frames, etc.).

A vehicle is difficult to move in a diagonal direction without rotation due to the characteristics of vehicle dynamics. Accordingly, the average vector of converged vectors obtained by applying the particle filter is exploded into a rotation matrix “R” and a straight component in an x direction. Thereafter, the coordinate calibration matrix for the yaw value (a rotation about the z axis) is obtained from a component of ‘R’. The error in the x (sensor position) value and the y (sensor position) value may not be recognized between the sensor and the vehicle, except when a portion of the vehicle interferes with the sensor to be perceived (e.g., a roof-mounted LiDAR partially occluded by an antenna or mirror housing, etc.). The error in the x and y values is ignored on the assumption that the impact on the cognitive performance of autonomous driving by the x and y values is limited, and coordinate calibration is completed (e.g., small lateral offsets under 5 cm do not affect perception accuracy, etc.).

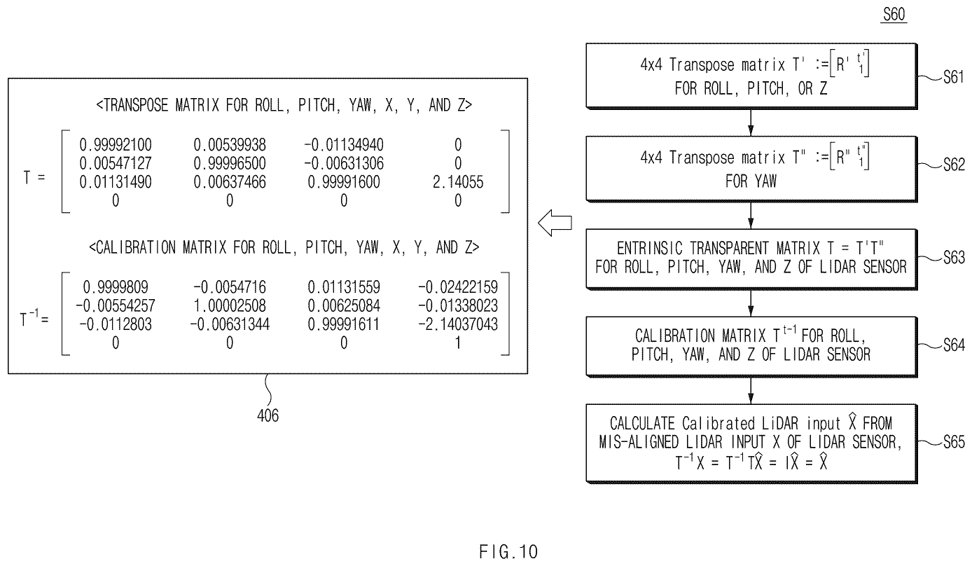

FIG. 10 shows an example of a process (that is, step ‘S60’) for performing calibration for a roll value, a pitch value, a yaw value, or a z value according to an example of the present disclosure.

Referring to FIG. 10, in ‘S61’, a 4×4 transpose matrix for the roll value, the pitch value, and the z value is obtained. In ‘S62’, a 4×4 transpose matrix for the yaw value is obtained. In ‘S63’, an extrinsic transpose matrix is calculated with respect to the roll value, the pitch value, the yaw value, or the z value of the LiDAR 120. In ‘S64’, a coordinate calibration matrix is found with respect to the roll value, the pitch value, the yaw value, or the z value of the LiDAR 120. Thereafter, in ‘S65’, a LIDAR input (\hat{X}), which is obtained by calibrating a misaligned LiDAR input (X) of the LiDAR 120 (e.g., transforming raw point-cloud coordinates into the vehicle reference frame, thereby correcting for tilt or vertical offset, etc.). Reference numeral 406 in FIG. 10 indicates the transpose matrix T and the coordinate calibration matrix T⁻¹ for the roll value, the pitch value, the yaw value, the x value, the y value, and the z value. When the LiDAR point cloud, which is obtained from the sensor, is transformed using the coordinate calibration matrix T⁻¹, the LiDAR input, which is coordinate-calibrated, may be obtained (e.g., aligning all LiDAR points to the vehicle's reference coordinate frame for accurate perception and control, etc.).

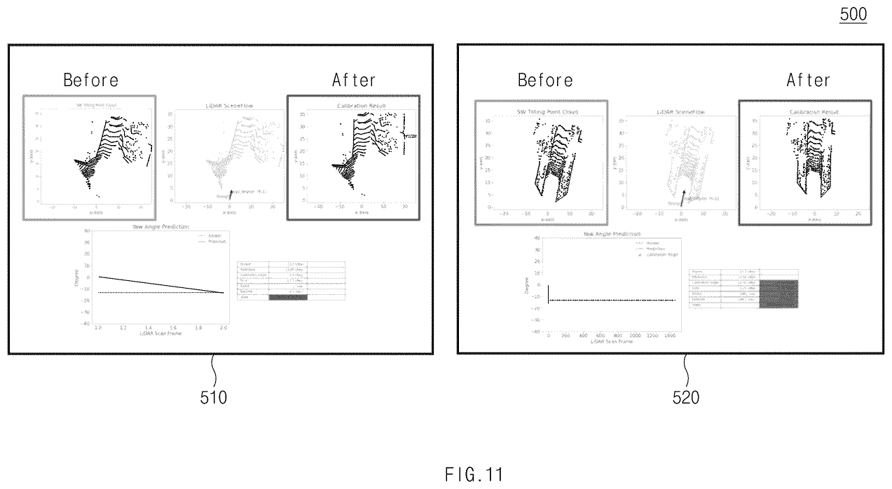

FIG. 11 shows an example of an experiment result 500 obtained by calibrating 3D sensor coordinates based on scene flow, according to an example of the present disclosure. Reference numeral 510 indicates the use of only one scene. Referring to reference numeral 510, it may be recognized that coordinate recognition is improved between a ‘BEFORE’ state in which the present disclosure is not applied, and an ‘AFTER’ state in which the present disclosure is applied. Reference numeral 520 indicates that the LiDAR coordinate calibration is performed based on the accumulation result over time. Referring to reference numeral 520, it may be recognized that a better coordinate calibration value is obtained in the ‘AFTER’ state (e.g., reduced angular error between LiDAR and vehicle frames from 2.5° to 0.3°, etc.).

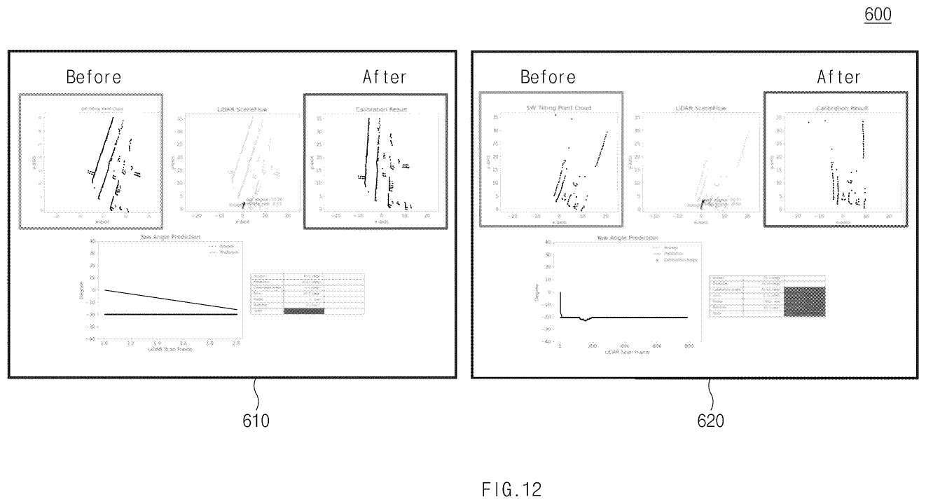

FIG. 12 shows an example of an experiment result 600 obtained by calibrating 3D sensor coordinates based on scene flow, according to another example of the present disclosure. Reference numeral 610 indicates the use of only one scene. Referring to reference numeral 610, it may be recognized that coordinate recognition is improved between a ‘BEFORE’ state in which the present disclosure is not applied, and an ‘AFTER’ state in which the present disclosure is applied. Reference numeral 620 indicates that the LiDAR coordinate calibration is performed based on the accumulation result over time. Referring to reference numeral 620, it may be recognized that a better coordinate calibration value is obtained in the ‘AFTER’ state (e.g., showing smoother alignment of object boundaries in BEV and 3D views, etc.).

According to the present disclosure, a LiDAR rolling shutter phenomenon may be handled. In the case of a scanning LiDAR, several milliseconds (ms) are required to generate data for one frame, to cause distortion in the data. When utilizing the scene flow data information which may be obtained according to the present disclosure, correction may be achieved in a point unit, and the rolling shutter problem may be reduced (e.g., compensating for slight vehicle motion or vibration between early and late scan lines, etc.). When the rolling shutter phenomenon is solved, recognition and positioning performance are improved, thereby ensuring the driving quality and safety of the autonomous vehicle.

In addition, according to the present disclosure, a failure or a defective mounting of the LiDAR 120 may be diagnosed. In other words, the frequency of misalignment of the specific sensor may be analyzed through the real-time coordinate calibration. When the misalignment is caused periodically, with at least the frequency of misalignment, the failure or the defective mounting of the LiDAR 120 may be determined. If the misalignment of the specific sensor is caused in at least an average misalignment range, the failure or the defective mounting of the LiDAR 120 may be determined (e.g., vibration-induced sensor tilt exceeding 0.5° per hour, etc.).

Further, according to the present disclosure, the LiDAR clustering and tracking performance may be improved. The clustering and tracking performance are improved using flow information in a point unit. A hard object should have the same movement. Accordingly, when the flow information is utilized as a feature, the clustering performance for an object in a range near the hard object may be improved (e.g., grouping multiple vehicle surface points into one cluster even when partially occluded, etc.). In addition, the change in position/speed of the object may be estimated by utilizing the flow information, thereby improving the tracking performance (e.g., predicting pedestrian trajectories with lower latency, etc.).

According to the present disclosure, the coordinate calibration may be implemented between the sensor and the vehicle, rather than between sensors. Accordingly, the position and the posture of the host vehicle may be accurately estimated based on the measurement value of the sensor. The present disclosure suggests an extrinsic calibration manner for more widely working in various situations, instead of an algorithm working only in a situation satisfying a specific rule. In addition, the present disclosure suggests a manner for utilizing a cognition result of a vision sensor as an external parameter of the vision sensor, by utilizing that the static object and the scene flow are physical values directly corresponding to the odometry of the host vehicle (e.g., integrating LiDAR scene flow with camera-based visual odometry, etc.).

Coordinate calibration is required to calculate the relative distance to the host vehicle and the movement of the host vehicle by recognizing the surrounding environment from the sensor in an autonomous driving field. When the coordinate calibration is performed between mutually different sensors, the coordinate systems of the sensors may be aligned with each other. However, the coordinate system of the vehicle may not be aligned with the coordinate system of the sensor (e.g., a LiDAR axis deviating from the vehicle's forward axis, causing localization drift, etc.).

In general, the alignment between the coordinate system of the sensor and the coordinate system of the vehicle may be performed through Factory Calibration performed based on a specific fixed object. For software, the Factory Calibration requires about 10 minutes, which makes it practically significantly difficult to apply in real-time autonomous driving. For example, the coordinate calibration is not finished even at a time point at which a driver of the autonomous driving vehicle activates the autonomous driving option. Accordingly, various options related to the autonomous driving may not work normally (e.g., delayed activation of lane-centering or object-tracking modules, etc.).

In addition, a coordinate calibration software, which is rule-based software designed under the assumption of a specific situation, may not ensure normal correction, when the vehicle is not a relevant specific situation. For example, when the coordinate calibration is performed based on a specific structure, such as a straight road, a guide rail, or another vehicle, and an environment, and when an object such as the specific structure is absent, the coordinate calibration may not be performed. In addition, the coordinate calibration software has lower scalability. Accordingly, when a specification easily changes in sensor hardware, a vehicle type, and a sensor mounting position, high-cost software modification is inevitable (e.g., retraining or manual parameter adjustment for each model variant, etc.).

According to the present disclosure, the misalignment may be recognized between the LiDAR coordinate system and the vehicle coordinate system, and the error values of SixDegrees of Freedom (6-DOF) may be estimated for calibration using hardware or software. In particular, sensor misalignment (that is, coordinate misalignment) may be recognized during vehicle driving under a general road environment, without a specific place or a specific device for coordinate calibration (e.g., enabling self-calibration while cruising on highways or in urban traffic, etc.).

Further, according to the present disclosure, a coordinate calibration architecture employs an error calculating manner based on AI learning to firmly correct software under a general situation without requiring a specific structure or a specific environment. The background points may be distinguished, based on a segmentation learning model instead of the specific structure, to detect points for a static object, such as a building or a road (e.g., classifying background planes from point clouds using a pre-trained semantic segmentation network, etc.).

According to the present disclosure, the errors are not calculated using a feature directly extracted based on a rule, but an End-to-End manner is employed to output the error based on the result of the learning model in real time. In addition, correction accuracy is improved using an optical flow which is a manner to obtain vectors mapped one-to-one between points as learning features. In other words, the cost required for coordinate calibration is reduced and scalability is ensured by employing a self-supervised learning manner without labeled ground truth (GT). Furthermore, the data is expanded into 3D data and configured to track scene flow in a 3D scene of the real world (e.g., associating LiDAR points between consecutive frames to infer vehicle-motion vectors, etc.). In this case, the scene flow refers to the flow between a time point ‘t−1’ and a time point ‘t’ of individual points included in the point cloud.

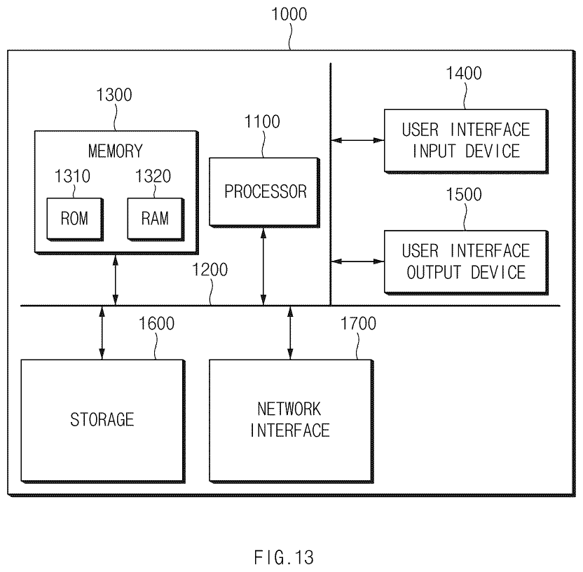

FIG. 13 shows an example of a computing system 1000 for computation to control an autonomous driving vehicle and to calculate an object recognition computation, according to an example of the present disclosure.

Referring to FIG. 13, the computing system 1000 may include at least one processor 1100, a memory 1300, a user interface input device 1400, a user interface output device 1500, a storage 1600, and a network interface 1700, which are connected with each other via a bus 1200 (For example, the computing system 1000 may represent an embedded control unit of an autonomous vehicle or a server used for model training.).

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM) For example, the ROM may store firmware or boot code, while the RAM may temporarily store sensor-fusion data and AI inference results.

Thus, the operations of the methods or algorithms described in connection with the examples disclosed in the present disclosure may be directly implemented with a hardware module, a software module, or the combination of two modules, executed by the processor 1100. The software module may reside on a storage medium (that is, the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). For example, the software may include machine-learning models for sensor-coordinate calibration and object recognition.

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal. For example, the ASIC may perform real-time LiDAR calibration while the host CPU handles higher-level driving control.

A first example of the present disclosure relates to a system for recognizing an object by an artificial intelligence (AI) module and an autonomous driving sensor. A system for calibrating a three-dimensional (3D) sensor coordinate based on a scene flow network is suggested as the first example of the present disclosure. The system includes a processor to include, as a portion of the AI module, an object recognition module mounted in the processor to recognize the object present under a surrounding environment, based on multiple pieces of point data which is input from the autonomous driving sensor, and a memory to store the multiple pieces of point data which is input. The AI module performs a first step for training and executing the scene flow network, which outputs a scene flow, in real time based on input data from the autonomous driving sensor, a second step for performing motion segmentation with respect to points including a static object or a dynamic object present under the surrounding environment, a third step for extracting a representative static object vector by applying a particle filter to the input data, which is temporally and spatially accumulated, from the autonomous driving sensor, and a fourth step for calibrating coordinates of the autonomous driving sensor, using at least one of a roll value, a pitch value, a yaw value, or a z value of the representative static object vector.

In a system for calibrating a 3D sensor coordinate based on a scene flow network according to a second example of the present disclosure, the AI module recognizes a point, which corresponds to a ground plane, based on the input data from the autonomous driving sensor, estimates initial coordinate-calibration values with respect to a 3 Degrees of Freedom (3-DOF) including the roll value, the pitch value, or the z value, and additionally performs a ground plane fitting process for removing the recognized ground plane.

In a system for calibrating a 3D sensor coordinate based on a scene flow network according to a third example of the present disclosure, the ground plane fitting process is performed in parallel to the first step.

In a system for calibrating a 3D sensor coordinate based on a scene flow network according to a fourth example of the present disclosure, in the scene flow network, the autonomous driving sensor calculates a tilting angle and a height with respect to an x axis, a y axis, and a z axis to find the roll value, the pitch value, the yaw value, and the z value, such that a scene flow vector is obtained, accumulates and validates the scene flow vector over time to recognize misalignment of a coordinate system of the autonomous driving sensor.

In a system for calibrating a 3D sensor coordinate based on a scene flow network according to a fifth example of the present disclosure, the ground fitting process is performed through an algorithm of Rule-based Random Sample Consensus (RANSAC) or Patchwork++.

In a system for calibrating a 3D sensor coordinate based on a scene flow network according to a sixth example of the present disclosure, the ground plane fitting process includes a process for calculating a coordinate calibration matrix for the roll value, the pitch value, and the z value, on an assumption that a short-range ground plane is perpendicular to the z axis.

In a system for calibrating a 3D sensor coordinate based on a scene flow network according to a seventh example of the present disclosure, a point cloud frame, which is obtained as the ground plane is removed through the ground plane fitting process, is the input data in the first step.

In a system for calibrating a 3D sensor coordinate based on a scene flow network according to an eighth example of the present disclosure, the motion segmentation is performed on an assumption that the number of points of the static object is larger than the number of points of the dynamic object under the surrounding environment.

In a system for calibrating a 3D sensor coordinate based on a scene flow network according to a ninth example of the present disclosure, the third step includes a process for classifying points, which have at least a specific threshold value when compared to an average value of whole scene flow vectors, as the dynamic object and excluding the points when selecting the representative static object vector.

In a system for calibrating a 3D sensor coordinate based on a scene flow network according to a tenth example of the present disclosure, the fourth step is performed on an assumption that the representative static object vector is parallel to a straight-driving odometry of a host vehicle mounted with the autonomous driving sensor.

An eleventh example of the present disclosure relates to a method for recognizing an object and a surrounding environment by an artificial intelligence (AI) module and an autonomous driving sensor. A method for calibrating a three-dimensional (3D) sensor coordinate based on a scene flow network is suggested as the eleventh example of the present disclosure, the method includes a first step for training and executing the scene flow network, which outputs a scene flow, in real time based on input data from the autonomous driving sensor, by the AI module, a second step for performing motion segmentation with respect to points including a static object or a dynamic object present under a surrounding environment, by the AI module, a third step for extracting a representative static object vector by applying a particle filter to the input data, which is temporally and spatially accumulated, from the autonomous driving sensor, by the AI module, and a fourth step for calibrating coordinates of the autonomous driving sensor, using at least one of a roll value, a pitch value, a yaw value, or a z value of the representative static object vector, by the AI module.

As described above, according to the present disclosure, the coordinate calibration may be implemented between the sensor and the vehicle, rather than between sensors. Accordingly, the position and posture of the host vehicle may be accurately estimated based on the measurement values of the sensor. The present disclosure suggests an extrinsic calibration manner capable of operating in various situations, instead of an algorithm that works only in a situation satisfying a specific rule. In addition, the present disclosure suggests a manner for utilizing a cognition result of a vision sensor as an external parameter of the vision sensor, by utilizing the fact that the static object and the scene flow are physical values directly corresponding to the odometry of the host vehicle.

Coordinate calibration is required to calculate the relative distance to the host vehicle and the movement of the host vehicle by recognizing the surrounding environment using the sensor in an autonomous driving field. When the coordinate calibration is performed between mutually different sensors, the coordinate systems of the sensors may be aligned with each other. However, the coordinate system of the vehicle may not be aligned with the coordinate system of the sensor.

In general, the alignment between the coordinate system of the sensor and the coordinate system of the vehicle may be performed through Factory Calibration based on a specific fixed object. For software, the Factory Calibration requires about 10 minutes, which makes it practically difficult to apply in real-time autonomous driving. For example, the coordinate calibration may not be finished even at a time point at which a driver of the autonomous driving vehicle activates the autonomous driving option. Accordingly, various options related to the autonomous driving may not work normally.

In addition, a coordinate calibration software, which is rule-based software designed under the assumption of a specific situation, may not ensure normal correction, when the vehicle is not in that specific situation. For example, when the coordinate calibration is performed based on a specific structure, such as a straight road, a guide rail, or another vehicle, and an environment, and when an object such as the specific structure is absent, the coordinate calibration may not be performed. In addition, the coordinate calibration software has lower scalability. Accordingly, when a specification easily changes in sensor hardware, a vehicle type, and a sensor mounting position, a high-cost software modification is inevitable.

The present disclosure is provided to solve the problem of the related art. In other words, according to the present disclosure, the misalignment may be recognized between the LiDAR coordinate system and the vehicle coordinate system, and the error values of SixDegrees of Freedom (6-DOF) may be estimated for calibration using hardware or software. In particular, sensor misalignment (that is, coordinate misalignment) may be recognized during vehicle driving under a general road environment, without using a specific place or a specific device for coordinate calibration.

Further, according to the present disclosure, a coordinate calibration architecture employs an error calculating manner based on AI learning to accurately correct software under a general situation without requiring a specific structure or a specific environment. The background points may be distinguished based on a segmentation learning model instead of the specific structure, to detect points for a static object, such as a building or a road.

According to the present disclosure, the errors are not calculated using a feature directly extracted based on a rule, but an End-to-End manner is employed to output the error based on the result of the learning model in real time. In addition, correction accuracy is improved using an optical flow, which is a manner of obtaining vectors mapped one-to-one between points as learning features. In other words, the cost required for coordinate calibration is reduced and scalability is ensured by employing a self-supervised learning manner without labeled ground truth (GT). Furthermore, the data is expanded into 3D data and configured to track scene flow in a 3D scene of the real world. In this case, the scene flow refers to the flow between a time point ‘t−1’ and a time point ‘t’ of individual points included in the point cloud.

Besides, a variety of effects including the above effects may be understood with reference to the detailed description and accompanying drawings by those skilled in the art.

The above description is merely an example of the technical idea of the present disclosure, and various modifications and alternations may be made by one skilled in the art without departing from the essential characteristics of the present disclosure.

Therefore, the examples of the present disclosure are provided to explain the spirit and scope of the present disclosure, but not to limit them, so that the spirit and scope of the present disclosure are not limited by the examples. The scope of the present disclosure should be construed on the basis of the accompanying claims, and all the technical ideas within the scope equivalent to the claims should be included in the scope of the present disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure as defined in the following claims.

What is claimed is:

1. An apparatus of a vehicle, the apparatus comprising:
a sensor configured to obtain a plurality of pieces of point data associated with at least one object in a surrounding environment of the vehicle;
a memory configured to store the plurality of pieces of point data; and
a processor circuit configured to:
based on the plurality of pieces of point data, train and execute an artificial intelligence (AI) model to output a scene flow in real time, wherein the scene flow is associated with motion vectors each representing a movement of a point in the plurality of pieces of point data between two consecutive time points,
perform motion segmentation on the plurality of pieces of point data, wherein at least part of the plurality of pieces of point data is associated with a static object or a dynamic object present in the surrounding environment,
extract a representative static object vector by applying a particle filter to the plurality of pieces of point data, wherein the plurality of pieces of point data is accumulated from different positions of the sensor at different time points from the sensor, and
adjust coordinates of the sensor, using at least one of:
a roll value of the representative static object vector,
a pitch value of the representative static object vector,
a yaw value of the representative static object vector, or
a height value of the representative static object vector.

2. The apparatus of claim 1, wherein the processor circuit is configured to:
recognize a point, which is associated with a ground plane, based on the plurality of pieces of point data,
estimate initial coordinate-calibration values with respect to a 3 Degrees of Freedom (3-DOF), wherein the 3-DOF comprises at least one of the roll value, the pitch value, or the height value, and
perform a ground plane fitting process for removing the ground plane.

3. The apparatus of claim 2, wherein the ground plane fitting process is performed in parallel with the training and execution of the AI model.

4. The apparatus of claim 1, wherein the processor circuit is configured to execute the AI model to:
determine, via the sensor, a tilting angle and a height with respect to axes of a three-dimensional coordinate system of the vehicle,
based on the tilting angle and the height, determine the roll value, the pitch value, the yaw value, and the height value,
based on the roll value, the pitch value, the yaw value, and the height value, obtain a scene flow vector, and
accumulate and validate the scene flow vector over time to recognize misalignment of a coordinate system of the sensor.

5. The apparatus of claim 2, wherein the ground plane fitting process is performed using an algorithm comprising at least one of Rule-based Random Sample Consensus (RANSAC) or Patchwork++.

6. The apparatus of claim 2, wherein the ground plane fitting process comprises:
determining a coordinate calibration matrix for the roll value, the pitch value, and the height value, based on a ground plane detected within a threshold distance from the vehicle, wherein the ground plane is perpendicular to a height axis of a coordinate system of the vehicle.

7. The apparatus of claim 2, wherein the ground plane is removed from the plurality of pieces of point data via the ground plane fitting process to obtain a point cloud frame, wherein the training and execution of the AI model is based on the point cloud frame.

8. The apparatus of claim 1, wherein the motion segmentation is performed based on a number of points associated with the static object being larger than a number of points associated with the dynamic object.

9. The apparatus of claim 4, wherein the processor circuit is configured to:
classify, as dynamic objects, points having a value exceeding a threshold value, wherein the threshold value is defined based on an average value of scene flow vectors associated with the dynamic objects and static objects, and
exclude the points classified as the dynamic objects when selecting the representative static object vector from scene flow vectors associated with the static objects.

10. The apparatus of claim 1, wherein the adjustment of coordinates of the sensor is performed based on the representative static object vector being parallel to a movement vector, wherein the movement vector corresponds to straight-line travel of the vehicle, and wherein the vehicle is mounted with the sensor.

11. A method performed by an apparatus of a vehicle, the method comprising:
obtaining, via a sensor of the vehicle, a plurality of pieces of point data associated with at least one object in a surrounding environment of the vehicle;
based on the plurality of pieces of point data, training and executing an artificial intelligence (AI) model to output a scene flow in real time, wherein the scene flow associated with motion vectors each representing a movement of a point in the plurality of pieces of point data between two time points;
performing motion segmentation on the plurality of pieces of point data, wherein at least part of the plurality of pieces of point data is associated with a static object or a dynamic object present in the surrounding environment;
extracting a representative static object vector by applying a particle filter to the plurality of pieces of point data, wherein the plurality of pieces of point data are temporally and spatially accumulated from the sensor; and
adjusting coordinates of the sensor, using at least one of:
a roll value of the representative static object vector,
a pitch value of the representative static object vector,
a yaw value of the representative static object vector, or
a height value of the representative static object vector.

12. The method of claim 11, wherein the method further comprises:
recognizing a point, which is associated with a ground plane, based on the plurality of pieces of point data;
estimating initial coordinate-calibration values with respect to a 3 Degrees of Freedom (3-DOF), wherein the 3-DOF comprises at least one of the roll value, the pitch value, or the height value; and
executing a ground plane fitting process for removing the ground plane.

13. The method of claim 12, wherein the executing of the ground plane fitting process is performed in parallel to the training and executing of the AI model.

14. The method of claim 11, wherein the adjusting of the coordinates of the sensor comprises:
determining, via the sensor, a tilting angle and a height with respect to axes of a three-dimensional coordinate system of the vehicle;
based on the tilting angle and the height, determining the roll value, the pitch value, the yaw value, and the height value;
based on the roll value, the pitch value, the yaw value, and the height value, obtaining a scene flow vector; and
accumulating and validating the scene flow vector over time to recognize misalignment of a coordinate system of the sensor.

15. The method of claim 12, wherein the ground plane fitting process comprises:
determining a coordinate calibration matrix for the roll value, the pitch value, and the height value, based on a ground plane detected within a threshold distance from the vehicle, wherein the ground plane is perpendicular to a height axis of a coordinate system of the vehicle.

16. A vehicle comprising:
a sensor;
a driving control circuit configured to control autonomous driving of the vehicle; and
a processor circuit configured to:
obtain point cloud data at different time points from the sensor,
identify a plurality of static objects based on the point cloud data,
compare positional changes of the plurality of static objects between the different time points,
determine, based on the comparison of the positional changes, a misalignment between coordinates of the sensor and coordinates of the vehicle,
output, based on the misalignment, a signal indicating calibration parameters, wherein the calibration parameters comprise at least one of a roll value, a pitch value, a yaw value, or a height value,
adjust, based on the signal, the coordinates of the sensor such that the coordinates of the sensor are aligned with the coordinates of the vehicle, and
control, via the driving control circuit and based on the adjusted coordinates of the sensor, autonomous driving of the vehicle.

17. The vehicle of claim 16, wherein the processor circuit is configured to classify points of the point cloud data obtained at the different time points, wherein the classified points comprise points corresponding to the plurality of static objects and points corresponding to a plurality of moving objects.

18. The vehicle of claim 16, wherein the processor circuit is configured to extract a static object vector by aggregating motion vectors associated with the plurality of static objects,
wherein the motion vectors each represent a movement of a point in the point cloud data between two time points,
wherein the plurality of static objects are obtained from the point cloud data, and
wherein the point cloud data is obtained from different positions of the sensor at the different time points.

19. The vehicle of claim 18, wherein the processor circuit is configured to apply a particle filter to the motion vectors so that the motion vectors converge toward the static object vector.

20. The vehicle of claim 18, wherein the processor circuit is configured to, based on the static object vector, update the calibration parameters in real time during driving of the vehicle.
